(19) United States
(12) Patent Application Publication
(10) Pub. No.: US 2023/0156702 A1
(43) Pub. Date: May 18, 2023

(54) METHOD AND APPARATUS FOR DOWNLINK SMALL DATA TRANSMISSION OPERATION IN MOBILE COMMUNICATION SYSTEM

(71) Applicant: ELECTRONICS AND TELECOMMUNICATIONS RESEARCH INSTITUTE, Daejeon (KR)

(72) Inventor: Jae Heung KIM, Daejeon (KR)

(21) Appl. No.: 17/989,727

(22) Filed: Nov. 18, 2022

(30) Foreign Application Priority Data
Nov. 18, 2021 (KR) 10-2021-0159635
Nov. 17, 2022 (KR) 10-2022-0154085

(51) Int. Cl. H04W 72/12; H04W 76/30; H04W 76/28; H04W 74/08

(52) U.S. Cl. CPC H04W 72/1273; H04W 76/30; H04W 76/28; H04W 74/0841

(57) ABSTRACT

A method for receiving a DL SDT, performed by a terminal, may include: receiving DL SDT-related configuration information from a base station; receiving information indicating a DL SDT reception operation from the base station; transmitting a response to the information indicating the DL SDT reception operation to the base station; and receiving a DL SDT packet from the base station.

### CROSS-REFERENCE TO RELATED APPLICATIONS

This application claims priority to Korean Patent Applications No. 10-2021-0159635, filed on Nov. 18, 2021, and No. 10-2022-0154085, filed on Nov. 17, 2022, with the Korean Intellectual Property Office (KIPO), the entire contents of which are hereby incorporated by reference.

### BACKGROUND

### 1. Technical Field

Exemplary embodiments of the present disclosure relate to a method and an apparatus for transmitting or receiving a downlink data packet, and more specifically, to a method and an apparatus for transmission or receiving a downlink small data transmission (SDT) packet occurring intermittently in a mobile communication system using a high frequency band above millimeter wave (mmWave).

### 2. Description of Related Art

In order to cope with the rapidly increasing wireless data, a mobile communication system considers a transmission frequency band of 6 GHz to 90 GHz for a wide system bandwidth. In such a high frequency range, a small base station is assumed due to deterioration of reception signal performance due to path loss and reflection of radio waves.

In order to deploy a mobile communication system based on small base stations having small service coverages in consideration of the millimeter wave frequency band of 6 GHz to 90 GHz, a functional split method in which functions of a base station are configured as being split into a plurality of remote radio transmission and reception blocks and one centralized baseband processing block may be applied instead of deploying small base stations in which all of radio protocol functions of the mobile communication system are implemented. In addition, a method of configuring the mobile communication system by utilizing a plurality of transmission and reception points (TRPs) using functions such as a carrier aggregation, dual connectivity, duplication transmission, and the like may be considered.

In a mobile communication system to which such the functional split function, bi-casting function, or duplication transmission function is applied, radio resource management methods and control signaling methods for transmission/reception of intermittently occurring small data transmission (SDT) packets are required.

### SUMMARY

Exemplary embodiments of the present disclosure are directed to providing an operation method of a base station for transmission an SDT packet occurring in the base station.

Exemplary embodiments of the present disclosure are also directed to providing an operation method of a terminal for receiving a downlink SDT packet.

Exemplary embodiments of the present disclosure are also directed to providing a base station apparatus transmitting an SDT packet and a terminal apparatus receiving the SDT packet.

According to a first exemplary embodiment of the present disclosure, a method for receiving a downlink (DL) small data transmission (SDT), performed by a terminal, may comprise: receiving DL SDT-related configuration information from a base station; receiving information indicating a DL SDT reception operation from the base station; transmitting a response to the information indicating the DL SDT reception operation to the base station; and receiving a DL SDT packet from the base station.

The DL SDT packet may be a size less than or equal to a predetermined size and may include intermittently generated data or signaling information.

The DL SDT-related configuration information may be received from the base station through a control message for transitioning the terminal to a radio resource control (RRC) connection released state.

The information indicating the DL SDT reception operation may be received as being included in a physical downlink control channel (PDCCH) monitored and received in a time region according to a semi-persistent scheduling (SPS) periodicity indicated by the DL SDT-related configuration information or a discontinuous reception (DRX) operation cycle.

The PDCCH may be received using a predefined paging scheduling identifier or a scheduling identifier assigned to the terminal through the DL SDT-related configuration information.

The method may further comprise, before the transmitting of the response, determining whether the terminal needs to perform a procedure for maintaining uplink synchronization with the base station or whether the uplink synchronization is valid.

The method may further comprise: in response to determining that the procedure for maintaining uplink synchronization with the base station needs to be performed, performing a random access (RA) procedure to the base station or transmitting an uplink signal for acquiring uplink synchronization with the base station to the base station by using an uplink radio resource indicated by the information indicating the DL SDT reception operation.

In the receiving of the DL SDT packet, information on a timing advance (TA) based on the RA procedure or the uplink signal for acquiring uplink synchronization with the base station may be additionally received.

The method may further comprise transmitting, to the base station, hybrid automatic repeat request (HARQ) feedback information and/or control information for the DL SDT packet.

The control information may include at least one of a result of measuring a quality of a radio channel between the base station and the terminal, a channel quality indicator (CQI) for downlink scheduling between the base station and the terminal, information indicating whether uplink data occurs, assistant information of the terminal, preference information of the terminal, or combinations thereof.

The method may further comprise, after the receiving of the DL SDT packet, transitioning to an RRC idle state or remaining in an RRC inactive state according to configuration or indication of the base station.

According to a second exemplary embodiment of the present disclosure, a method for a downlink (DL) small data transmission (SDT) operation, performed by a base station, may comprise: transmitting DL SDT-related configuration information to a terminal; transmitting information indicating a DL SDT reception operation to the terminal; receiving a response to the information indicating the DL SDT reception operation from the terminal; and transmitting a DL SDT packet to the terminal.

The DL SDT packet may have a size less than or equal to a predetermined size and may include intermittently generated data or signaling information.

The DL SDT-related configuration information may be transmitted to the terminal through a control message for transitioning the terminal to a radio resource control (RRC) connection released state.

The information indicating the DL SDT reception operation may be transmitted to the terminal in a time region according to a semi-persistent scheduling (SPS) periodicity indicated by the DL SDT-related configuration information or a discontinuous reception (DRX) operation cycle.

The transmitting of the DL SDT packet may further comprise: transmitting, to the terminal, information on a timing advance (TA) based on a random access procedure with the terminal or an uplink signal received from the terminal for uplink synchronization acquisition.

According to a third exemplary embodiment of the present disclosure, a terminal in a mobile communication system may comprise: a processor; and a transceiver controlled by the processor, wherein the processor is executed to perform: receiving DL SDT-related configuration information from a base station through the transceiver; receiving information indicating a DL SDT reception operation from the base station through the transceiver; transmitting a response to the information indicating the DL SDT reception operation to the base station through the transceiver; and receiving a DL SDT packet from the base station through the transceiver.

The information indicating the DL SDT reception operation may be received as being included in a physical downlink control channel (PDCCH) monitored and received in a time region according to a semi-persistent scheduling (SPS) periodicity indicated by the DL SDT-related configuration information or a discontinuous reception (DRX) operation cycle.

The processor may be further executed to perform: before the transmitting of the response, determining whether the terminal needs to perform a procedure for maintaining uplink synchronization with the base station or whether the uplink synchronization is valid.

The processor may be further executed to perform: in response to determining that the procedure for maintaining uplink synchronization with the base station needs to be performed, performing a random access (RA) procedure to the base station or transmitting an uplink signal for acquiring uplink synchronization with the base station to the base station by using an uplink radio resource indicated by the information indicating the DL SDT reception operation.

Using the exemplary embodiments of the present disclosure, the terminal can efficiently receive intermittently occurring downlink SDT packets and/or non-SDT packets from the base station in consideration of the operation state of the terminal and available radio resources. In addition, errors that may occur in reception of the SDT packets and/or non-SDT packets can also be easily overcome, thereby improving the system performance.

### BRIEF DESCRIPTION OF DRAWINGS

FIG. 1 is a conceptual diagram illustrating an exemplary embodiment of a communication system.

FIG. 2 is a block diagram illustrating an exemplary embodiment of a communication node constituting a communication system.

FIG. 3 is a conceptual diagram illustrating another exemplary embodiment of a communication system.

FIG. 4 is a conceptual diagram illustrating an exemplary embodiment of a method of configuring bandwidth parts (BWPs) in a communication system.

FIG. 5 is a conceptual diagram illustrating an exemplary embodiment of operation states of a terminal in a communication system.

FIG. 6 is a sequence chart illustrating a downlink SDT method based on a 4-step random access procedure according to an exemplary embodiment of the present disclosure.

FIG. 7 is a sequence chart illustrating a downlink SDT method based on a 2-step random access procedure according to an exemplary embodiment of the present disclosure.

FIG. 8 is a sequence chart illustrating a downlink SDT method based on SPS resources according to an exemplary embodiment of the present disclosure.

### DETAILED DESCRIPTION OF THE EMBODIMENTS

Embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may mean “at least one of A or B” or “at least one of combinations of one or more of A and B”. Also, in exemplary embodiments of the present disclosure, “one or more of A and B” may mean “one or more of A or B” or “one or more of combinations of one or more of A and B”.

In exemplary embodiments of the present disclosure, “(re)transmission” may mean “transmission”, “retransmission”, or “transmission and retransmission”, “(re)configuration” may mean “configuration”, “reconfiguration”, or “configuration and reconfiguration”, “(re)connection” may mean “connection”, “reconnection”, or “connection and reconnection”, and “(re)access” may mean “access”, “re-access”, or “access and re-access”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, preferred exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may be used in the same sense as a communication network.

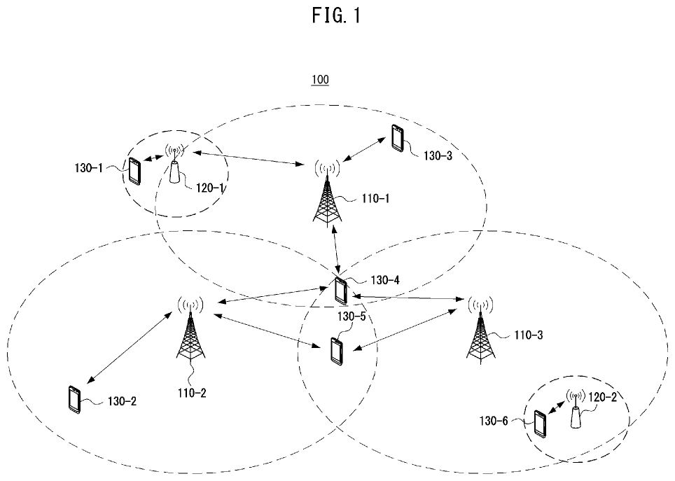

FIG. 1 is a conceptual diagram illustrating an exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4th generation (4G) communication (e.g., long term evolution (LTE), LTE-advanced (LTE-A)), 5th generation (5G) communication (e.g., new radio (NR)), or the like. The 4G communication may be performed in a frequency band of 6 gigahertz (GHz) or below, and the 5G communication may be performed in a frequency band of 6 GHz or above.

For example, for the 4G and 5G communications, the plurality of communication nodes may support a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, a filtered OFDM based communication protocol, a cyclic prefix OFDM (CP-OFDM) based communication protocol, a discrete Fourier transform spread OFDM (DFT-s-OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, a generalized frequency division multiplexing (GFDM) based communication protocol, a filter bank multi-carrier (FBMC) based communication protocol, a universal filtered multi-carrier (UFMC) based communication protocol, a space division multiple access (SDMA) based communication protocol, or the like.

Also, the communication system 100 may further include a core network. When the communication system 100 supports the 4G communication, the core network may comprise a serving gateway (S-GW), a packet data network (PDN) gateway (P-GW), a mobility management entity (MME), and the like. When the communication system 100 supports the 5G communication, the core network may comprise a user plane function (UPF), a session management function (SMF), an access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

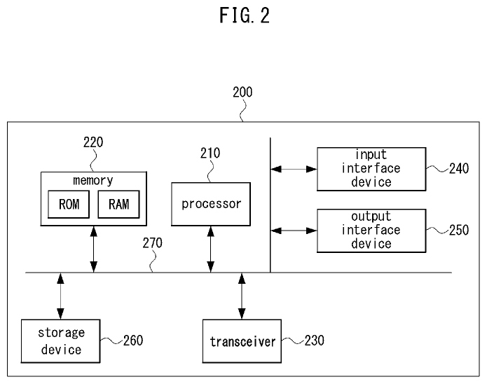

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may be connected to the processor 210 via an individual interface or a separate bus, rather than the common bus 270. For example, the processor 210 may be connected to at least one of the memory 220, the transceiver 230, the input interface device 240, the output interface device 250, and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. The communication system 100 including the base stations 110-1, 110-2, 110-3, 120-1, and 120-2 and the terminals 130-1, 130-2, 130-3, 130-4, 130-5, and 130-6 may be referred to as an ‘access network’. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, a evolved Node-B (eNB), a base transceiver station (BTS), a radio base station, a radio transceiver, an access point, an access node, a road side unit (RSU), a radio remote head (RRH), a transmission point (TP), a transmission and reception point (TRP), an eNB, a gNB, or the like.

Here, each of the plurality of terminals 130-1, 130-2, 130-3, 130-4, 130-5, and 130-6 may refer to a user equipment (UE), a terminal, an access terminal, a mobile terminal, a station, a subscriber station, a mobile station, a portable subscriber station, a node, a device, an Internet of things (IoT) device, a mounted apparatus (e.g., a mounted module/device/terminal or an on-board device/terminal, etc.), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

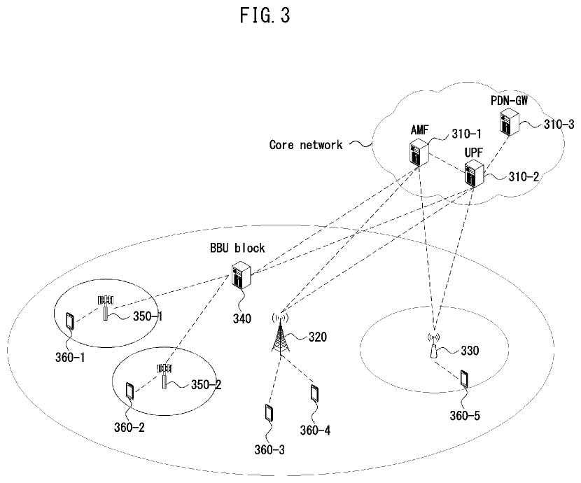

FIG. 3 shows a connection method (example) between a base station and a core network in a wireless communication network using fronthaul and backhaul. In a wireless communication network, a base station 310 (or macro base station) or a small base station 330 is connected to a termination node 340 of the core network through a wired backhaul 380. Here, the termination node of the core network may be a serving gateway (SGW), a user plane function (UPF), a mobility management entity (MME), or an access and mobility function (AMF).

In addition, when a function of the base station is configured as being split in to a baseband processing function block 360 (e.g., baseband unit (BBU) or cloud platform) and a remote radio transmission/reception node 320 (e.g., remote radio head (RRH), transmission & reception point (TRP)), they are connected through a wired fronthaul 370.

The functions of the baseband processing function block 360 may be located in the base station 310 that supports a plurality of remote radio transmit/receive nodes 320 or may be configured as logical functions in the middle of the base station 310 and the SGW/MME (or UPF/AMF) 340 to support a plurality of base stations. In this case, the functions of the baseband processing function block 360 may be physically configured independently of the base station 310 and the SGW/MME 340 or operated as being installed in the base station 310 (or SGW/MME 340).

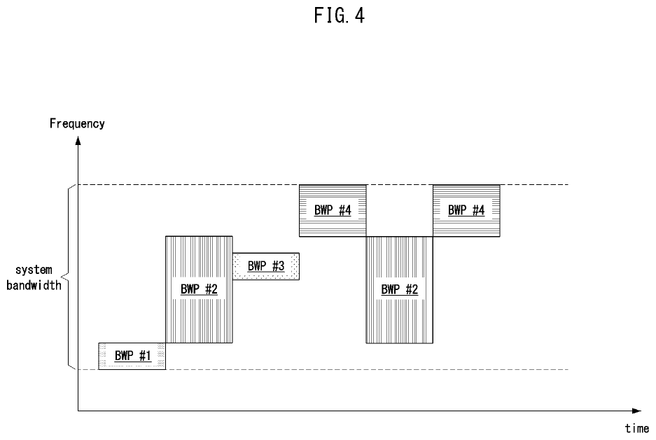

Each of remote radio transmission/reception nodes 320, 420-1, and 420-2 of FIGS. 3 and 4 and base stations 110-1, 110-2, 110-3, and 120-1 shown in FIGS. 1, 3, and 4 may support OFDM, OFDMA, SC-FDMA, or NOMA-based downlink transmission and uplink transmission. In a case where the remote radio transmission/reception nodes of FIGS. 3 and 4 and the plurality of base stations shown in FIGS. 1, 3, and 4 support beamforming functions by using antenna arrays through a transmission carrier of a mmWave band, each may provide services without interference between beams within a base station through a formed beam, and provide services for a plurality of terminals (or UEs) within one beam.

Also, each of the plurality of base stations 110-1, 110-2, 110-3, 120-1, and 120-2 may support multi-input multi-output (MIMO) transmission (e.g., a single-user MIMO (SU-MIMO), multi-user MIMO (MU-MIMO), massive MIMO, or the like), coordinated multipoint (CoMP) transmission, carrier aggregation (CA) transmission, transmission in an unlicensed band, device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, operation methods for SDT in a communication system will be described. Even when a method (e.g., transmission or reception of a signal) performed at a first communication node among communication nodes is described, the corresponding second communication node may perform a method (e.g., reception or transmission of the signal) corresponding to the method performed at the first communication node. That is, when an operation of a terminal is described, the corresponding base station may perform an operation corresponding to the operation of the terminal. Conversely, when an operation of the base station is described, the corresponding terminal may perform an operation corresponding to the operation of the base station.

In the following description, the UPF (or, S-GW) may refer to a termination communication node of the core network that exchanges packets (e.g., control information, data) with the base station, and the AMF (or, MME) may refer to a communication node in the core network, which performs control functions in a radio access section (or, interface) of the terminal. Here, each of the backhaul link, fronthaul link, Xhaul link, DU, CU, BBU block, S-GW, MME, AMF, and UPF may be referred to as a different term according to a function (e.g., function of the Xhaul network, function of the core network) of a communication protocol depending on a radio access technology (RAT).

In order to perform a mobility support function and a radio resource management function, the base station may transmit a synchronization signal (e.g., a synchronization signal/physical broadcast channel (SS/PBCH) block) and/or a reference signal. In order to support multiple numerologies, frame formats supporting symbols having different lengths may be configured. In this case, the terminal may perform a monitoring operation on the synchronization signal and/or reference signal in a frame according to an initial numerology, a default numerology, or a default symbol length. Each of the initial numerology and the default numerology may be applied to a frame format applied to radio resources in which a UE-common search space is configured, a frame format applied to radio resources in which a control resource set (CORESET) #0 of the NR communication system is configured, and/or a frame format applied to radio resources in which a synchronization symbol burst capable of identifying a cell in the NR communication system is transmitted.

The frame format may refer to information of configuration parameters (e.g., values of the configuration parameters, offset, index, identifier, range, periodicity, interval, duration, etc.) for a subcarrier spacing, control channel (e.g., CORESET), symbol, slot, and/or reference signal. The base station may inform the frame format to the terminal using system information and/or a control message (e.g., dedicated control message).

The terminal connected to the base station may transmit a reference signal (e.g., uplink dedicated reference signal) to the base station using resources configured by the corresponding base station. For example, the uplink dedicated reference signal may include a sounding reference signal (SRS). In addition, the terminal connected to the base station may receive a reference signal (e.g., downlink dedicated reference signal) from the base station in resources configured by the corresponding base station. The downlink dedicated reference signal may be a channel state information-reference signal (CSI-RS), a phase tracking-reference signal (PT-RS), a demodulation-reference signal (DM-RS), or the like. Each of the base station and the terminal may perform a beam management operation through monitoring on a configured beam or an active beam based on the reference signal.

For example, the first base station 611 may transmit a synchronization signal and/or a reference signal so that the first terminal 621 located within its service area can search for itself to perform downlink synchronization maintenance, beam configuration, or link monitoring operations. The first terminal 621 connected to the first base station 611 (e.g., serving base station) may receive physical layer radio resource configuration information for connection configuration and radio resource management from the first base station 611. The physical layer radio resource configuration information may mean configuration parameters included in RRC control messages of the LTE communication system or the NR communication system. For example, the resource configuration information may include PhysicalConfigDedicated, PhysicalCellGroupConfig, PDCCH-Config(Common), PDSCH-Config(Common), PDCCH-ConfigSIB1, ConfigCommon, PUCCH-Config(Common), PUSCH-Config(Common), BWP-DownlinkCommon, BWP-UplinkCommon, ControlResourceSet, RACH-ConfigCommon, RACH-ConfigDedicated, RadioResourceConfigCommon, RadioResourceConfigDedicated, ServingCellConfig, ServingCellConfigCommon, and the like.

The radio resource configuration information may include parameter values such as a configuration (or allocation) periodicity of a signal (or radio resource) according to a frame format of the base station (or transmission frequency), time resource allocation information for transmission, frequency resource allocation information for transmission, a transmission (or allocation) time, or the like. In order to support multiple numerologies, the frame format of the base station (or transmission frequency) may mean a frame format having different symbol lengths according to a plurality of subcarrier spacings within one radio frame. For example, the number of symbols constituting each of a mini-slot, slot, and subframe that exist within one radio frame (e.g., a frame of 10 ms) may be configured differently.
Configuration information of transmission frequency and frame format of base station

Transmission frequency configuration information: information on all transmission carriers (i.e., cell-specific transmission frequency) in the base station, information on bandwidth parts (BWPs) in the base station, information on a transmission reference time or time difference between transmission frequencies of the base station (e.g., a transmission periodicity or offset parameter indicating the transmission reference time (or time difference) of the synchronization signal), etc.

Frame format configuration information: configuration parameters of a mini-slot, slot, and subframe having a different symbol length according to a subcarrier spacing
Configuration information of downlink reference signal (e.g., channel state information-reference signal (CSI-RS), common reference signal (Common-RS), etc.)

Configuration parameters such as a transmission periodicity, transmission position, code sequence, or masking (or scrambling) sequence for a reference signal, which are commonly applied within the coverage of the base station (or beam).
Configuration information of uplink control signal

Configuration parameters such as a sounding reference signal (SRS), uplink beam sweeping (or beam monitoring) reference signal, uplink grant-free radio resources (or, preambles), etc.
Configuration information of physical downlink control channel (e.g., PDCCH)

Configuration parameters such as a reference signal for PDCCH demodulation, beam common reference signal (e.g., reference signal that can be received by all terminals within a beam coverage), beam sweeping (or beam monitoring) reference signal, reference signal for channel estimation, etc.
Configuration information of physical uplink control channel (e.g., PUCCH)
Scheduling request signal configuration information
Configuration information for a feedback (acknowledgement (ACK) or negative ACK (NACK)) transmission resource in a hybrid automatic repeat request (HARQ) procedure
Number of antenna ports, antenna array information, beam configuration or beam index mapping information for application of beamforming techniques
Configuration information of downlink signal and/or uplink signals (or uplink access channel resource) for beam sweeping (or beam monitoring)
Configuration information of parameters for beam configuration, beam recovery, beam reconfiguration, or radio link re-establishment operation, beam change operation within the same base station, reception signal of a beam triggering a handover procedure to another base station, timers controlling the above-described operations, etc.

In case of a radio frame format that supports a plurality of symbol lengths for supporting multi-numerology, the configuration (or allocation) periodicity of the parameter, the time resource allocation information, the frequency resource allocation information, the transmission time, and/or the allocation time, which constitute the above-described information, may be information configured for each corresponding symbol length (or subcarrier spacing).

In the following exemplary embodiments, ‘Resource-Config information’ may be a control message including one or more parameters of the physical layer radio resource configuration information. In addition, the ‘Resource-Config information’ may mean attributes and/or configuration values (or range) of information elements (or parameters) delivered by the control message. The information elements (or parameters) delivered by the control message may be radio resource configuration information applied commonly to the entire coverage of the base station (or, beam) or radio resource configuration information allocated dedicatedly to a specific terminal (or, specific terminal group). A terminal group may include one or more terminals.

The configuration information included in the ‘Resource-Config information’ may be transmitted through one control message or different control messages according to the attributes of the configuration information. The beam index information may not express the index of the transmission beam and the index of the reception beam explicitly. For example, the beam index information may be expressed using a reference signal mapped or associated with the corresponding beam index or an index (or identifier) of a transmission configuration indicator (TCI) state for beam management.

Therefore, the terminal operating in the RRC connected state may receive a communication service through a beam (e.g., beam pair) configured between the terminal and the base station. For example, when a communication service is provided using beam configuration (e.g., beam pairing) between the base station and the terminal, the terminal may perform a search operation or a monitoring operation of a radio channel by using a synchronization signal (e.g., SS/PBCH block) and/or a reference signal (e.g., CSI-RS) of a beam configured with the base station, or a beam the can be received. Here, the expression that a communication service is provided through a beam may mean that a packet is transmitted and received through an active beam among one or more configured beams. In the NR communication system, the expression that a beam is activated may mean that a configured TCI state is activated.

The terminal may operate in the RRC idle state or the RRC inactive state. In this case, the terminal may perform a search operation (e.g., monitoring operation) of a downlink channel by using parameter(s) obtained from system information or common Resource-Config information. In addition, the terminal operating in the RRC idle state or the RRC inactive state may attempt to access by using an uplink channel (e.g., a random access channel or a physical layer uplink control channel). Alternatively, the terminal may transmit control information by using an uplink channel.

The terminal may recognize or detect a radio link problem by performing a radio link monitoring (RLM) operation. Here, the expression that a radio link problem is detected may mean that physical layer synchronization configuration or maintenance for a radio link has a problem. For example, the expression that a radio link problem is detected may mean that it is detected that the physical layer synchronization between the base station and the terminal is not maintained during a preconfigured time. When a radio link problem is detected, the terminal may perform a recovery operation of the radio link. When the radio link is not recovered, the terminal may declare a radio link failure (RLF) and perform a re-establishment procedure of the radio link.

The procedure for detecting a physical layer problem of a radio link, procedure for recovering a radio link, procedure for detecting (or declaring) a radio link failure, and procedure for re-establishing a radio link according to the RLM operation may be performed by functions of a layer 1 (e.g., physical layer), a layer 2 (e.g., MAC layer, RLC layer, PDCP layer, etc.), and/or a layer 3 (e.g., RRC layer) of the radio protocol.

The physical layer of the terminal may monitor a radio link by receiving a downlink synchronization signal (e.g., primary synchronization signal (PSS), secondary synchronization signal (SSS), SS/PBCH block) and/or a reference signal. In this case, the reference signal may be a base station common reference signal, beam common reference signal, or terminal (or terminal group) specific reference signal (e.g., dedicated reference signal allocated to a terminal (or terminal group)). Here, the common reference signal may be used for channel estimation operations of all terminals located within the corresponding base station or beam coverage (or service area). The dedicated reference signal may be used for a channel estimation operation of a specific terminal or a specific terminal group located within the base station or beam coverage.

Accordingly, when the base station or the beam (e.g., configured beam between the base station and the terminal) is changed, the dedicated reference signal for beam management may be changed. The beam may be changed based on the configuration parameter(s) between the base station and the terminal. A procedure for changing the configured beam may be required. The expression that a beam is changed in the NR communication system may mean that an index (or identifier) of a TCI state is changed to an index of another TCI state, that a TCI state is newly configured, or that a TCI state is changed to an active state. The base station may transmit system information including configuration information of the common reference signal to the terminal. The terminal may obtain the common reference signal based on the system information. In a handover procedure, synchronization reconfiguration procedure, or connection reconfiguration procedure, the base station may transmit a dedicated control message including the configuration information of the common reference signal to the terminal.

The configured beam information may include at least one of a configured beam index (or identifier), configured TCI state index (or identifier), configuration information of each beam (e.g., transmission power, beam width, vertical angle, horizontal angle), transmission and/or reception timing information of each beam (e.g., subframe index, slot index, mini-slot index, symbol index, offset), reference signal information corresponding to each beam, and reference signal identifier.

In the exemplary embodiments, the base station may be a base station installed in the air. For example, the base station may be installed on an unmanned aerial vehicle (e.g., drone), a manned aircraft, or a satellite.

The terminal may receive configuration information of the base station (e.g., identification information of the base station) from the base station through one or more of an RRC message, MAC message, and PHY message, and may identify a base station with which the terminal performs a beam monitoring operation, radio access operation, and/or control (or data) packet transmission and reception operation.

The result of the measurement operation (e.g., beam monitoring operation) for the beam may be reported through a physical layer control channel (e.g., PUCCH) and/or a MAC message (e.g., MAC CE, control PDU). Here, the result of the beam monitoring operation may be a measurement result for one or more beams (or beam groups). For example, the result of the beam monitoring operation may be a measurement result for beams (or beam groups) according to a beam sweeping operation of the base station.

The base station may obtain the result of the beam measurement operation or the beam monitoring operation from the terminal, and may change the properties of the beam or the properties of the TCI state based on the result of the beam measurement operation or the beam monitoring operation. The beam may be classified into a primary beam, a secondary beam, a reserved (or candidate) beam, an active beam, and a deactivated beam according to its properties. The TCI state may be classified into a primary TCI state, a secondary TCI state, a reserved (or candidate) TCI state, a serving TCI state, a configured TCI state, an active TCI state, and a deactivated TCI state according to its properties. Each of the primary TCI state and the secondary TCI state may be assumed to be an active TCI state and a serving TCI state. The reserved (or candidate) TCI state may be assumed to be a deactivated TCI state or a configured TCI state.

Each of the primary TCI state and the secondary TCI state may be assumed to be an active TCI state or a serving TCI state capable of transmitting or receiving data packets or control signaling even with restriction. In addition, the reserved (or candidate) TCI state may be assumed to be a deactivate TCI state or a configured TCI state in which data packets or control signaling cannot be transmitted or received while being a measurement or management target.

A procedure for changing the beam (or TCI state) property may be controlled by the RRC layer and/or the MAC layer. When the procedure for changing the beam (or TCI state) property is controlled by the MAC layer, the MAC layer may inform the higher layer of information regarding a change in the beam (or TCI state) property. The information regarding the change in the beam (or TCI state) property may be transmitted to the terminal through a MAC message and/or a physical layer control channel (e.g., PDCCH). The information regarding the change in the beam (or TCI state) property may be included in downlink control information (DCI) or uplink control information (UCI). The information regarding the change in the beam (or TCI state) property may be expressed as a separate indicator or field.

The terminal may request to change the property of the TCI state based on the result of the beam measurement operation or the beam monitoring operation. The terminal may transmit control information (or feedback information) requesting to change the property of the TCI state to the base station by using one or more of a PHY message, a MAC message, and an RRC message. The control information (or feedback information, control message, control channel) requesting to change the property of the TCI state may be configured using one or more of the configured beam information described above.

The change in the property of the beam (or TCI state) may mean a change from the active beam to the deactivated beam, a change from the deactivated beam to the active beam, a change from the primary beam to the secondary beam, a change from the secondary beam to the primary beam, a change from the primary beam to the reserved (or candidate) beam, or a change from the reserved (or candidate) beam to the primary beam. The procedure for changing the property of the beam (or TCI state) may be controlled by the RRC layer and/or the MAC layer. The procedure for changing the property of the beam (or TCI state) may be performed through partial cooperation between the RRC layer and the MAC layer.

When a plurality of beams are allocated, one or more beams among the plurality of beams may be configured as beam(s) for transmitting physical layer control channels. For example, the primary beam and/or the secondary beam may be used for transmission and reception of a physical layer control channel (e.g., PHY message). Here, the physical layer control channel may be a PDCCH or a PUCCH. The physical layer control channel may be used for transmission of one or more among scheduling information (e.g., radio resource allocation information, modulation and coding scheme (MCS) information), feedback information (e.g., channel quality indication (CQI), precoding matrix indicator (PMI), HARQ ACK, HARQ NACK), resource request information (e.g., scheduling request (SR)), result of the beam monitoring operation for supporting beamforming functions, TCI state ID, and measurement information for the active beam (or deactivated beam).

The physical layer control channel may be configured to be transmitted through the primary beam of downlink. In this case, the feedback information may be transmitted and received through the primary beam, and data scheduled by the control information may be transmitted and received through the secondary beam. The physical layer control channel may be configured to be transmitted through the primary beam of uplink. In this case, the resource request information (e.g., SR) and/or the feedback information may be transmitted and received through the primary beam.

In the procedure of allocating the plurality of beams (or the procedure of configuring the TCI states), the allocated (or configured) beam indices, information indicating a spacing between the beams, and/or information indicating whether contiguous beams are allocated may be transmitted and received through a signaling procedure between the base station and the terminal. The signaling procedure of the beam allocation information may be performed differently according to status information (e.g., movement speed, movement direction, location information) of the terminal and/or the quality of the radio channel. The base station may obtain the status information of the terminal from the terminal. Alternatively, the base station may obtain the status information of the terminal through another method.

The radio resource information may include parameter(s) indicating frequency domain resources (e.g., center frequency, system bandwidth, PRB index, number of PRBs, CRB index, number of CRBs, subcarrier index, frequency offset, etc.) and parameter(s) indicating time domain resources (e.g., radio frame index, subframe index, transmission time interval (TTI), slot index, mini-slot index, symbol index, time offset, and periodicity, length, or window of transmission period (or reception period)). In addition, the radio resource information may further include a hopping pattern of radio resources, information for beamforming (e.g., beam shaping) operations (e.g., beam configuration information, beam index), and information on resources occupied according to characteristics of a code sequence (or bit sequence, signal sequence).

The name of the physical layer channel and/or the name of the transport channel may vary according to the type (or attribute) of data, the type (or attribute) of control information, a transmission direction (e.g., uplink, downlink, sidelink), and the like.

The reference signal for beam (or TCI state) or radio link management may be a synchronization signal (e.g., PSS, SSS, SS/PBCH block), CSI-RS, PT-RS, SRS, DM-RS, or the like. The reference parameter(s) for reception quality of the reference signal for beam (or TCI state) or radio link management may include a measurement time unit, a measurement time interval, a reference value indicating an improvement in reception quality, a reference value indicating a deterioration in reception quality, or the like. Each of the measurement time unit and the measurement time interval may be configured in units of an absolute time (e.g., millisecond, second), TTI, symbol, slot, frame, subframe, scheduling periodicity, operation periodicity of the base station, or operation periodicity of the terminal.

The reference value indicating the change in reception quality may be configured as an absolute value (dBm) or a relative value (dB). In addition, the reception quality of the reference signal for beam (or TCI state) or radio link management may be expressed as a reference signal received power (RSRP), a reference signal received quality (RSRQ), a received signal strength indicator (RSSI), a signal-to-noise ratio (SNR), a signal-to-interference ratio (SIR), or the like.

Meanwhile, in the NR communication system using a millimeter frequency band, flexibility for a channel bandwidth operation for packet transmission may be secured based on a bandwidth part (BWP) concept. The base station may configure up to 4 BWPs having different bandwidths to the terminal. The BWPs may be independently configured for downlink and uplink. That is, downlink BWPs may be distinguished from uplink BWPs. Each of the BWPs may have a different subcarrier spacing as well as a different bandwidth. For example, BWPs may be configured as follows.

FIG. 4 is a conceptual diagram illustrating an exemplary embodiment of a method of configuring bandwidth parts (BWPs) in a communication system.

As shown in FIG. 4, a plurality of bandwidth parts (e.g., BWPs #1 to #4) may be configured within a system bandwidth of the base station. The BWPs #1 to #4 may be configured not to be larger than the system bandwidth of the base station. The bandwidths of the BWPs #1 to #4 may be different, and different subcarrier spacings may be applied to the BWPs #1 to #4. For example, the bandwidth of the BWP #1 may be 10 MHz, and the BWP #1 may have a 15 kHz subcarrier spacing. The bandwidth of the BWP #2 may be 40 MHz, and the BWP #2 may have a 15 kHz subcarrier spacing. The bandwidth of the BWP #3 may be 10 MHz, and the BWP #3 may have a 30 kHz subcarrier spacing. The bandwidth of the BWP #4 may be 20 MHz, and the BWP #4 may have a 60 kHz subcarrier spacing.

The BWPs may be classified into an initial BWP (e.g., first BWP), an active BWP (e.g., activated BWP), and a default BWP. The terminal may perform an initial access procedure (e.g., access procedure) with the base station in the initial BWP. One or more BWPs may be configured through an RRC connection configuration message, and one BWP among the one or more BWPs may be configured as the active BWP. Each of the terminal and the base station may transmit and receive packets in the active BWP among the configured BWPs. Therefore, the terminal may perform a monitoring operation on control channels for packet transmission and reception in the active BWP.

The terminal may switch the operating BWP from the initial BWP to the active BWP or the default BWP. Alternatively, the terminal may switch the operating BWP from the active BWP to the initial BWP or the default BWP. The BWP switching operation may be performed based on an indication of the base station or a timer. The base station may transmit information indicating the BWP switching to the terminal using one or more of an RRC message, a MAC message (e.g., MAC control element (CE)), and a PHY message (e.g., DCI). The terminal may receive the information indicating the BWP switching from the base station, and may switch the operating BWP of the terminal to a BWP indicated by the received information.

When a random access (RA) resource is not configured in the active uplink (UL) BWP in the NR communication system, the terminal may switch the operating BWP of the terminal from the active UL BWP to the initial UL BWP in order to perform a random access procedure. The operating BWP may be a BWP in which the terminal performs communication (e.g., transmission and reception operation of a signal and/or channel).

Measurement operations (e.g., monitoring operations) for beam (or TCI state) or radio link management may be performed at the base station and/or the terminal. The base station and/or the terminal may perform the measurement operations (e.g., monitoring operations) according to parameter(s) configured for the measurement operations (e.g., monitoring operations). The terminal may report a measurement result according to parameter(s) configured for measurement reporting.

When a reception quality of a reference signal according to the measurement result meets a preconfigured reference value and/or a preconfigured timer condition, the base station may determine whether to perform a beam (or, radio link) management operation, a beam switching operation, or a beam deactivation (or, activation) operation according to a beam blockage situation. When it is determined to perform a specific operation, the base station may transmit a message triggering execution of the specific operation to the terminal. For example, the base station may transmit a control message for instructing the terminal to execute the specific operation to the terminal. The control message may include configuration information of the specific operation.

When a reception quality of a reference signal according to the measurement result meets a preconfigured reference value and/or a preconfigured timer condition, the terminal may report the measurement result to the base station. Alternatively, the terminal may transmit to the base station a control message triggering a beam (or, radio link) management operation, a beam switching operation (or a TCI state ID change operation, a property change operation), or a beam deactivation operation (or a beam activation operation) according to a beam blockage situation. The control message may request to perform a specific operation.

A basic procedure for beam (or TCI state) management through the radio link monitoring may include a beam failure detection (BFD) procedure, a beam recovery (BR) request procedure, and the like for a radio link. An operation of determining whether to perform the beam failure detection procedure and/or the beam recovery request procedure, an operation triggering execution of the beam failure detection procedure and/or the beam recovery request procedure, and a control signaling operation for the beam failure detection procedure and/or the beam recovery request procedure may be performed by one or more of the PHY layer, the MAC layer, and the RRC layer.

The procedure for the terminal to access the base station (e.g., random access procedure) may be classified into an initial access procedure and a non-initial access procedure. The terminal operating in the RRC idle state may perform the initial access procedure. Alternatively, when there is no context information managed by the base station, the terminal operating in the RRC connected state may also perform the initial access procedure. The context information may include RRC context information, access stratum (AS) configuration information (e.g., AS context information), and the like. The context information may include one or more among RRC configuration information for the terminal, security configuration information for the terminal, PDCP information including a robust header compression (ROHC) state for the terminal, an identifier (e.g., cell-radio resource temporary identifier (C-RNTI)) for the terminal, and an identifier of the base station for which a connection configuration with the terminal has been completed.

The non-initial access procedure may refer to an access procedure performed by the terminal in addition to the initial access procedure. For example, the non-initial access procedure may be performed for an access request for transmission or reception data arrival at the terminal, connection resumption, resource allocation request, user (UE) request based information transmission request, link re-establishment request after a radio link failure (RLF), mobility function (e.g., handover function) support, secondary cell addition/change, active beam addition/change, or physical layer synchronization configuration.

The random access procedure may be performed based on the initial access procedure or the non-initial access procedure according to the operation state of the terminal.

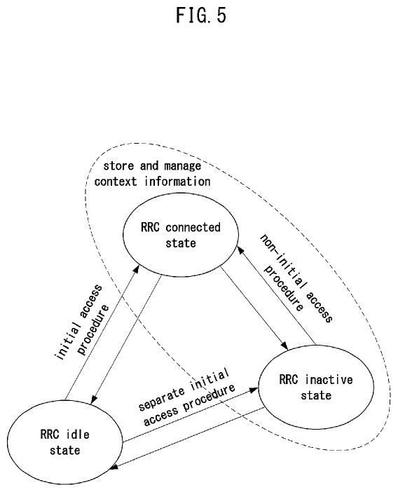

FIG. 5 is a conceptual diagram illustrating an exemplary embodiment of operation states of a terminal in a communication system.

As shown in FIG. 5, operation states of the terminal may be classified into an RRC connected state, an RRC inactive state, and an RRC idle state. When the terminal operates in the RRC connected state or the RRC inactive state, a radio access network (RAN) (e.g., a control function block of the RAN) and the base station may store and manage RRC connection configuration information and/or context information (e.g., RRC context information, AS context information) of the corresponding terminal.

The terminal operating in the RRC connected state may receive configuration information of physical layer control channels and/or reference signals required for maintaining connection configuration and transmission/reception of data from the base station. The reference signal may be a reference signal for demodulating the data. Alternatively, the reference signal may be a reference signal for channel quality measurement or beamforming. Therefore, the terminal operating in the RRC connected state may transmit and receive the data without delay.

When the terminal operates in the RRC inactive state, mobility management functions/operations identical or similar to mobility management functions/operations supported in the RRC idle state may be supported for the corresponding terminal. That is, when the terminal operates in the RRC inactive state, a data bearer for transmitting and receiving data may not be configured, and functions of the MAC layer may be deactivated. Accordingly, the terminal operating in the RRC inactive state may transition the operation state of the terminal from the RRC inactive state to the RRC connected state by performing the non-initial access procedure to transmit data. Alternatively, the terminal operating in the RRC inactive state may transmit data having a limited size, data having a limited quality of service, and/or data associated with a limited service.

When the terminal operates in the RRC idle state, there may be no connection configuration between the terminal and the base station, and the RRC connection configuration information and/or context information (e.g., RRC context information, AS context information) of the terminal may not be stored in the RAN (e.g., a control function block of the RAN) and the base station. In order to transition the operation state of the terminal from the RRC idle state to the RRC connected state, the terminal may perform the initial access procedure. Alternatively, when the initial access procedure is performed, the operation state of the terminal may transition from the RRC idle state to the RRC inactive state according to determination of the base station.

The terminal may transition from the RRC idle state to the RRC inactive state by performing the initial access procedure or a separate access procedure defined for the RRC inactive state. When a limited service is provided to the terminal, the operation state of the terminal may transition from the RRC idle state to the RRC inactive state. Alternatively, depending on capability of the terminal, the operation state of the terminal may transition from the RRC idle state to the RRC inactive state.

The base station and/or the control function block of the RAN may configure condition(s) for transitioning to the RRC inactive state by considering one or more of the type, capability, and service (e.g., a service currently being provided and a service to be provided) of the terminal, and may control the operation for transitioning to the RRC inactive state based on the configured condition(s). When the base station allows the transition to the RRC inactive state or when the transition to the RRC inactive state is configured to be allowed, the operation state of the terminal may be transitioned from the RRC connected state or the RRC idle state to the RRC inactive state.

Configuration and Conditions for Downlink Small Data Transmission (SDT)

Data having a small size and/or a signaling message having a small size (hereinafter referred to as ‘small data transmission (SDT)’) may occur intermittently. That is, the SDT may refer to data or signaling information that is intermittently occurring with a size less than or equal to a predetermined size. When an SDT occurs in the base station, the base station may perform the SDT to the terminal operating in the RRC idle state or the RRC inactive state.

Here, downlink SDT of the base station may be performed with downlink radio resources obtained through a paging procedure, a random access procedure, or a downlink configured grant (CG) (or semi-persistent scheduling) transmission procedure.

The base station may transmit configuration information related to downlink SDT to the terminal. For downlink SDT, the base station may transmit a paging message to the terminal, instruct the terminal to perform a random access (RA) procedure, or configure (or allocate) a downlink configured grant (CG) resource (hereinafter, SPS resource) for SDT transmission in advance and activate it so as to make the terminal to perform a reception operation. That is, the base station may configure a SPS resource for SDT transmission and transmit configuration information of the SPS resource to the terminal so that the terminal can receive a intermittently-occurring downlink SDT packet.

In addition, the base station may transmit, to the terminal and through system information or a separate control message, configuration information (i.e., configuration information for downlink SDT reception and/or uplink transmission operation of the terminal for the downlink SDT reception (hereinafter, DL SDT configuration information)) indicating whether downlink SDT reception using the paging procedure and/or RA procedure, or the SPS resource is allowed. Here, the uplink transmission operation of the terminal may mean a transmission operation of response information, HARQ feedback information, and/or beam pairing information for the reception of the SDT transmitted by the base station. Here, the separate control message may be a control message for RRC connection configuration, a control message for RRC connection release, an RRC state transition control message (e.g., a control message for transition the inactive state), MAC CE, and/or DCI information (or configuration parameters) of a physical layer control channel (PDCCH).

For the DL SDT operation, the base station may configure a DL SDT configuration information message (or information elements (IEs)) with one or more of the following information, and may transmit, to the terminal, the configured DL SDT configuration information message in form of system information or a separate control message.
Information notifying that there is no need for an operation (or procedure) for maintaining uplink synchronization (or information indicating that uplink synchronization is valid without restriction by a timer, etc.)
Information notifying that SDT reception using an SPS resource and uplink transmission (or DL SDT operation) are allowed even when uplink synchronization is not maintained
Information notifying that a timer (e.g., timeAlignmentTimer) value for an operation for maintaining uplink synchronization is set to infinity
Scheduling identifier configured for DL SDT operation (e.g., RNTI for SPS, RNTI for SDT paging, and/or C-RNTI, etc.)
Uplink RA resource configuration information configured for DL SDT operation
Information indicating whether SPS resource-based DL SDT operation is allowed
Information on a reference value (or threshold value) for determining whether SPS resource-based DL SDT operation is possible
SPS resource configuration information (SPS allocation periodicity, SPS start time/offset information, SPS end time information, and/or SPS validity timer, etc.)
DRX cycle for supporting DL SDT operation (e.g., DRX cycle, on-duration timer, DRX start offset, etc.)
Uplink resource configuration information for HARQ feedback transmission indicating whether SPS reception is successful (e.g., BWP index, frequency/time domain allocation information, etc.)
DL SDT operation BWP configuration information (e.g., frequency/time domain allocation information, BWP index, etc.)
DL SDT operation CORESET configuration information (e.g., frequency/time domain allocation information, CORESET index, etc.)
Scheduling identifier for DL SDT operation
DL SDT execution scheme indicator (or indication information)
DL SDT validity timer
DL SDT operation period
DL SDT one-shot transmission indicator

Here, the uplink RA resource configuration information configured for the DL SDT operation may mean configuration information of uplink RA radio resource(s) for a contention-based RA (i.e., CBRA) procedure and/or a non-contention-based RA (or contention-free random access (i.e., CFRA)) procedure. For example, the uplink RA resource configuration information may include RA occasion (RO) configuration parameters, RA preamble and mask configuration information, and/or information on association between 2-step RA preambles and PUSCH radio resources of MSG-A payload for 2-step RA procedure. When configured to include CFRA configuration information, the uplink RA resource configuration information may be configured to include an RA preamble index value dedicatedly allocated to a terminal performing a DL SDT reception operation, RA preamble mask value, and/or PUSCH radio resource configuration information for a MSG-A payload of a 2-step RA procedure.

In addition, the information indicating whether the SPS resource-based DL SDT operation may mean information indicating whether the SPS resource-based DL SDT operation is allowed regardless of whether uplink synchronization of the terminal is maintained or not or whether the uplink synchronization is acquired, based on a service coverage size of the base station, a uplink synchronization maintenance timer of the terminal, a channel quality of a radio link, a mobility state of the terminal, and/or location information of the terminal. In addition, the information on the reference value (or threshold value) for determining whether the SPS resource-based DL SDT operation may mean information on the reference value (or threshold value) used by the terminal to determine whether the SPS resource-based DL SDT operation is possible regardless of whether uplink synchronization of the terminal is maintained or not or whether the uplink synchronization is acquired, based on the service coverage size of the base station, the uplink synchronization maintenance timer of the terminal, the channel quality of the radio link, the mobility state of the terminal, and/or the location information of the terminal.

In addition, the SPS resource configuration information may mean frequency domain configuration information and time domain configuration information of radio resources and/or SPS resources for SDT operation. The time domain configuration information may include information such as a transmission start time and/or a transmission end time, an SDT operation period (or, window, timer, or counter), or a transmission periodicity within a transmission period.

In addition, the DL SDT execution scheme indicator (or indication information) may mean information indicating whether the DL SDT operation is performed using an SPS procedure or a paging message (or PDCCH) and/or RA procedure. Alternatively, the DL SDT execution scheme indicator (or indication information) may be information indicating priorities (or selection order) of selectable (or applicable) schemes.

In addition, the DL SDT validity timer may be information indicating a time during which the terminal can perform the DL SDT operation in the inactive or idle state after the DL SDT operation starts. When the DL SDT validity timer expires, the terminal may not perform the DL SDT operation. The DL SDT validity timer may be started at a time point at which the DL SDT operation is started (e.g., an SDT transmission time of the base station and/or an SDT reception time of the terminal) and/or (re)started every time the DL SDT operation is performed.

In addition, the DL SDT one-shot transmission indicator may be information indicating whether the DL SDT operation is performed as one-shot (or single) transmission or as one or more consecutive DL SDT operations. For example, the DL SDT one-shot transmission indicator set to ‘1’ may indicate one-time DL SDT operation, and the DL SDT one-shot transmission indicator set to ‘0’ may indicate one or more consecutive DL SDT operations. Here, the one-shot transmission means that a new transmission occurs once without retransmission according to a HARQ function. For example, when the DL SDT one-shot transmission indicator indicates that the DL SDT operation occurs one time, once the DL SDT operation is successfully performed, the started DL SDT operation ends. That is, when a new DL SDT operation is required, a DL SDT operation should be performed again from an initiation or triggering stage.

In the configuration information, the time domain allocation information (e.g., operation period, window, timer, counter, start time point, end time point, etc.) may be configured in units of radio frames, subframes, slots, minislots, or symbols. In addition, when the configuration information is transmitted as a MAC layer message, information indicating whether the configuration information is present and/or value(s) (or, configuration parameter range(s)) of the configuration information may be transmitted in form or a MAC (sub)header or a MAC (sub)PDU. For this, a separate logical channel identifier (LCID) may be set.

Meanwhile, the DL SDT reception operation may be performed using a paging procedure and/or an RA procedure, or using an SPS resource depending on the connection state of the terminal or whether uplink physical layer synchronization (hereinafter, uplink synchronization) of the terminal is maintained. For example, a terminal maintaining uplink synchronization or a terminal in the connected state may perform the DL SDT reception operation using a preconfigured SPS resource. On the other hand, a terminal in the inactive or idle state, a terminal that does not maintain uplink synchronization, a terminal for which an SPS resource is not configured, or a terminal in which a configured SPS resource is not valid may perform the DL SDT reception operation using a paging procedure and/or an RA procedure.

If an SPS resource for downlink SDT is not allocated in advance or a condition for performing the SPS resource-based DL SDT operation is not satisfied (e.g., when a configured SPS resource is not valid), the base station may performs the DL SDT operation by using a paging procedure and/or RA procedure.

In addition, even when an SPS resource for downlink SDT is configured, the base station may indicate SPS activation or initiation of the DL SDT operation by using a PDCCH (e.g., DCI or SMS for paging) signaling method described below.

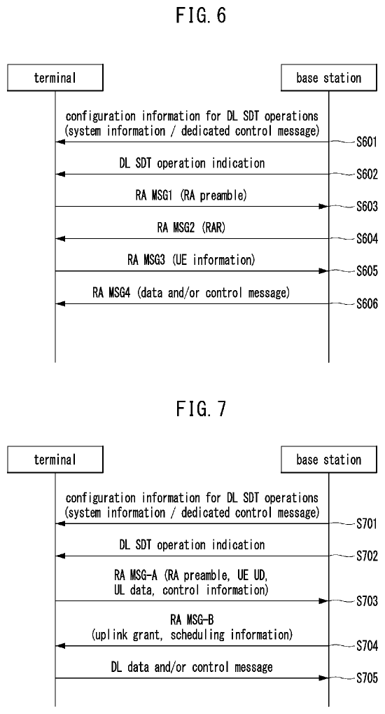

When an SPS resource for downlink SDT is not configured for the terminal in the inactive state or idle state, or an SPS resource configured for downlink SDT does not satisfy (or is not valid) the operating condition, the base station may transmit to the terminal information indicating a paging procedure or an RA procedure, thereby instructing the terminal to perform a DL SDT reception operation. Upon receiving a paging message indicating to perform the DL SDT reception operation or a PDCCH (or DCI) indicating to perform the RA procedure from the base station, the terminal may perform the DL SDT reception operation by using the RA procedure described below. The RA procedure for DL SDT may be performed as a radio access (or RA) procedure of a terminal consisting of four steps (4-step) or a radio access (or RA) procedure of a terminal consisting of two steps (2-step). Hereinafter, FIG. 6 is for describing an RA procedure composed of four steps (4-step), and FIG. 7 is for describing an RA procedure composed of two steps (2-step).

Downlink SDT Method Using 4-Step RA Procedure

FIG. 6 is a sequence chart illustrating a downlink SDT method based on a 4-step random access procedure according to an exemplary embodiment of the present disclosure.

Referring to FIG. 6, a communication system may include a base station, a terminal, and the like. The base station may be the base station 110-1, 110-2, 110-3, 120-1, or 120-2 shown in FIG. 1, and the terminal may be the terminal 130-1, 130-2, 130-3, 130-4, 130-5, or 130-6 shown in FIG. 1. The base station and the terminal may be configured to be the same or similar to the communication node shown in FIG. 2. A random access procedure may be performed in four steps.

The base station may transmit system information and/or a separate control message including the above-described DL SDT configuration information to the terminal (S601). The terminal may obtain the above-described DL SDT configuration information by receiving the system information and/or control message from the base station. The system information may be common system information used for a plurality of base stations or base station-specific system information (e.g., cell-specific system information). The control message may be a dedicated control message. The control message may be a dedicated control message. Here, the dedicated control message may be a control message for configuring an RRC connection, a control message for releasing an RRC connection, or an RRC state transition control message (e.g., a control message for transition to the inactive state).

The system information may be system information commonly applied to a plurality of base stations or system information for each base station. The system information may be configured for each base station, for each beam group, or for each beam. The system information may include configuration (or allocation) information of an RA radio resource (e.g., uplink radio resource) for DL SDT operation. The configuration information of the RA radio resource may include one or more of transmission frequency information of the physical layer, system bandwidth information (or BWP configuration information), subcarrier spacing information, beam configuration information according to a beamforming technique (e.g., beam width or beam index), variable radio resource configuration information (e.g., radio resource reference value or offset) in the frequency and/or time domain, and inactive (or unused) radio resource region/period information.

When a packet that meets a condition for being transmitted as DL SDT occurs, the base station may transmit information indicating a DL SDT reception operation to the terminal (or terminal group) (S602). In step S602, the base station may transmit control information indicating a DL SDT reception operation on a physical layer control channel (PDCCH). In this case, the PDCCH may be transmitted using a paging scheduling identifier (e.g., P-RNTI), a paging scheduling identifier for SDT (e.g., SDT P-RNTI), or a scheduling identifier (e.g., C-RNTI, CS-RNTI, SDT-RNTI, or SDT C-RNTI, etc.) pre-assigned to the terminal (or terminal group) based on the above-described DL SDT configuration information. That is, cyclic redundancy check (CRC) bits of the PDCCH may be transmitted as being scrambled by the corresponding scheduling identifier.

The PDCCH transmitted by the base station in step S602 to indicate the DL SDT reception operation may include one or more of the following information elements.
DL SDT reception operation execution indicator
Contention-free RA (or CFRA) configuration information (e.g., RA preamble index, PRACH mask index, etc.)
DL SDT operation BWP index
Scheduling identifier for DL SDT operation
DL SDT execution scheme indicator (or indication information)
DL SDT validity timer
DL SDT one-shot transmission indicator

However, when some of the above-described parameters are delivered to the terminal as being included in the above-described DL SDT configuration information, the PDCCH may not include the corresponding parameter(s). For example, when information on the RA preamble index in the contention-free RA (or CFRA) configuration information is delivered to the terminal using the above-described DL SDT configuration information, the information on the RA preamble index may not be included in the PDCCH. Alternatively, when the scheduling identifier for DL SDT operation is delivered to the terminal as being included in the above-described DL SDT configuration information, the information on the scheduling identifier for DL SDT operation may not be included in the PDCCH. That is, when the scheduling identifier (e.g., C-RNTI, CS-RNTI, SDT-RNTI, SDT C-RNTI, etc.) for DL SDT operation is pre-assigned to the terminal (or terminal group) using the DL SDT configuration information, the PDCCH of step S602 may be transmitted using the scheduling identifier assigned by the DL SDT configuration information. On the other hand, when the scheduling identifier for DL SDT operation is not pre-assigned by the DL SDT configuration information to the terminal (or terminal group), the PDCCH (e.g., DCI or SMS) in step S602 may be transmitted using a paging scheduling identifier or a paging scheduling identifier for SDT. In this case, the base station may deliver a DL SDT reception terminal (or terminal group) identifier for identifying the terminal or terminal group that is to receive the downlink SDT in step S602.

The terminal may transmit an RA MSG1 including an RA preamble to the base station using the radio resource (e.g., physical random access channel (PRACH)) configured by the DL SDT configuration information or PDCCH received from the base station (S603). The message 1 including the RA preamble may be referred to as an ‘RA MSG1’ in the 4-step random access procedure, and the RA preamble in the 4-step random access procedure may be referred to as a ‘4-step-RA preamble’.

An RA resource (or CFRA resource) such as an RA preamble index may be pre-allocated through the above-described DL SDT configuration information or PDCCH. The pre-allocation of the RA preamble may mean that an index, masking information, etc. of the RA preamble for the RA MSG1 is allocated dedicatedly to the terminal. In this case, the terminal may perform the random access procedure (e.g., CFRA procedure) without contention with other terminals.

When a CFRA resource for DL SDT operation is not allocated through the DL SDT configuration information message or PDCCH, the terminal may randomly select a code sequence (e.g., RA preamble or signature) defined for the RA procedure, and transmit the RA MSG1 including the selected code sequence. In a contention-based random access (CBRA) procedure, the terminal may randomly select the RA preamble.

The base station may receive the RA MSG1 from the terminal, and may generate and transmit a response message for the RA MSG1 (S604). That is, in step S604, the base station may generate or configure a response message for a random access request (or access attempt) and transmit it to the terminal. Hereinafter, the response message transmitted by the base station (or cell) in step S604 will referred to as an RA MSG2. The response message transmitted by the base station in step S604 may be transmitted on a PDCCH (e.g., downlink control information (DCI)) for allocating an uplink radio resource and/or a physical downlink shared channel (PDSCH), or may be transmitted only on a PDCCH for the RA response.

When the CFRA-based (or PDCCH order based) RA procedure is performed in step S603, a PDCCH allocating an uplink radio resource and/or PDSCH corresponding thereto may be transmitted in step S604. In this case, DCI transmitted on the PDCCH may include downlink resource allocation information (e.g., scheduling information), transmission timing adjustment information (e.g., a timing advance (TA) value and/or TA command), transmission power adjustment information, beam configuration information or TCI state information, configured scheduling (CS) state information, and/or PUCCH configuration information. Here, the beam configuration information may be information indicating activation or deactivation of a specific beam. The TCI state information may be information indicating activation or deactivation of a specific TCI state. The CS state information or SPS (or configured grant) state information may be information indicating activation or deactivation of radio resources allocated in the CS scheme. The state transition information may be information indicating transition of the operation state of the terminal shown in FIG. 5. The state transition information may indicate transition from a specific operation state to the RRC idle state, the RRC connected state, or the RRC inactive state. Alternatively, the state transition information may indicate maintaining of the current operation state. The PUCCH configuration information may be allocation information of a scheduling request (SR) resource. Alternatively, the PUCCH configuration information may be information indicating activation or deactivation of an SR resource.

The information not included in the DCI among the above-described information may be transmitted on a PDSCH addressed by downlink resource allocation information (e.g., scheduling information) transmitted through the DCI, and a DL SDT packet may be transmitted on the PDSCH.

In addition, when the terminal, to which a scheduling identifier (e.g., C-RNTI, SDT C-RNTI, etc.) for DL SDT operation is dedicatedly allocated using the DL SDT configuration information, performs the CFRA-based (or PDCCH order based) RA procedure in step S6-4, the PDCCH of step S604 may be transmitted using the pre-assigned scheduling identifier. In this case, the terminal may perform the DL SDT reception operation without performing steps S605 and S606 below. That is, when the PDCCH of step S604 is received using the pre-assigned scheduling identifier, the terminal may receive the DL SDT packet using the PDSCH addressed by the PDCCH. In addition, the terminal may also receive a DL SDT packet by using a PDSCH addressed by DCI transmitted using the scheduling identifier.

On the other hand, when a CBRA-based RA procedure is started in step S603, the base station may address a PDSCH for carrying an RA MSG2 (or RA response message) by using the PDCCH (or DCI) for RA response in step S604. The RA response message transmitted on the PDSCH may include uplink resource allocation information (e.g., scheduling information), transmission timing adjustment information (e.g., TA value and/or TA command), transmission power adjustment information, backoff information, information on an index of the RA preamble of the RA MSG1 received in step S603, uplink resource allocation information for transmission of an RA MSG3 in step S605, and the like. The control information not included in the RA response message may include one or more of beam configuration information or TCI state information, CS state information, state transition information, or PUCCH configuration information. The control information not included in the RA response message may be transmitted on a PDSCH in form of an MAC CE or may be transmitted using a PDCCH at every DL SDT operation.

When the contention-based RA (or CBRA) procedure is performed in step S603, the base station may transmit scheduling information of the RA MSG2 to the terminal using a random access (RA)-RNTI. For example, CRC bits of DCI including the scheduling information of the RA MSG2 may be scrambled by the RA-RNTI, and the DCI may be transmitted on the PDCCH. However, when the contention-free RA (or CFRA) procedure is performed in step S603, the base station may transmit the RA MSG2 using a C-RNTI.

The base station may transmit the RA MSG2 on a PDSCH indicated by the scheduling information addressed by the corresponding scheduling identifier (e.g., RA-RNTI, C-RNTI) according to the RA scheme performed in step S603.

As described above, when the terminal transmits a contention-free RA (or CFRA) preamble in step S603, and/or when the terminal receives the RA MSG2 using the scheduling identifier (e.g., C-RNTI, CS-RNTI, SDT-RNTI, SDT C-RNTI, etc.) dedicatedly assigned to the terminal, the terminal may receive a downlink SDT packet and/or control information element(s) in step S604. The control information element(s) in step S604 may include one or more among information indicating transition of the operation state of the terminal, information indicating maintaining the operation state of the terminal, information indicating activation or deactivation of a beam, information indicating activation or deactivation of a TCI state, or information indicating activation or deactivation of a CS state. When the DL SDT operation is terminated by successfully receiving the downlink SDT packet in step S604, the random access procedure may be terminated without performing step S605.

When the terminal receives the RA MSG2 in step S604, but an uplink radio resource of the RA MSG3 is not allocated, the terminal may wait until allocation information of the uplink radio resource for the RA MSG3 is received. When the allocation information of the uplink radio resource for the RA MSG3 is received before a preconfigured SDT operation timer expires, the terminal may transmit the RA MSG3 to the base station using the uplink radio resource. On the other hand, when the allocation information of the uplink radio resource for the RA MSG3 is not received until the preconfigured SDT operation timer expires, the terminal may perform the random access procedure again. That is, the terminal may perform again from the step S603.

A format (or configuration of parameters) of the RA response message for the RA MSG1 transmitted by the terminal for DL SDT operation and a format (or configuration of parameters) of the RA response message (i.e., RA MSG2) for an RA procedure for a different purpose may be different from each other. That is, the response message (i.e., RA MSG2) for the RA MSG1 transmitted by the terminal for DL SDT operation may include uplink radio resource allocation information for SDT. In this case, a MAC subheader for the RA MSG2 may include field parameter (or indicator) information indicating that the corresponding RA MSG2 is an RA MSG2 according to the 4-step RA procedure for SDT. For example, the corresponding indicator (or bit) set to ‘1’ may indicate that the corresponding RA MSG2 includes downlink radio resource allocation information for DL SDT, or that the corresponding RA MSG2 is an RA MSG 2 of a 4 step RA procured performed for DL SDT. The corresponding indicator (or bit) set to ‘0’ may indicate that the corresponding RA MSG2 does not include downlink radio resource allocation information for DL SDT, or that the corresponding RA MSG2 is an RA MSG2 of a 4 step RA procedure performed for a purpose other than DL SDT.

In addition, the RA MSG2 of the 4-step RA procedure performed for SDT operation may include a terminal identifier for DL SDT operation, transmission power adjustment information (e.g., TPC), PUCCH resource indicator, transmission timing adjustment information (e.g., TAC), MCS index, and/or downlink radio resource allocation information (or PUSCH resource indicator) for SDT. Here, the terminal identifier for SDT operation may be an identifier assigned to the terminal to identify the terminal in the inactive state, I-RNTI of the 3GPP NR system, a terminal identifier in an RRC resume request message (e.g., resumeIdentity of the 3GPP NR system, I-RNTI, or ShortI-RNTI), or the like.

After receiving the RA MSG2 from the base station, the terminal may transmit the RA MSG3 (i.e., message 3) including its own information (i.e., terminal (or UE) information) to the base station (S605). The terminal information may include one or more of an identifier of the terminal, capability, attribute, mobility state, location information, a reason for radio access, size information of uplink data to be transmitted (e.g., buffer status report (BSR)), connection establishment request information, or downlink measurement information. In addition, in step S605, the terminal may transmit a control message requesting necessary information to the base station in an on-demand manner. The base station may receive an uplink SDT packet and/or the control message requesting necessary information transmitted by the terminal in step S605.

In step S606, the base station may transmit the terminal identifier received from the terminal (e.g., the terminal identifier received in step S605) to the terminal. The message 4 transmitted by the base station in step S606 may be referred to as an ‘RA MSG4’. In addition, in step S606, the base station may transmit a downlink SDT packet (data or control message) to the terminal. When the terminal transmits the contention-based RA (or CBRA) preamble in step S603, the terminal may receive a downlink SDT packet transmitted by the base station after step S606 and/or step S606.

The base station may transmit resource allocation information (e.g., scheduling information) for transmission of the RA MSG3 to the terminal using the RA MSG2. The scheduling information may include one or more of the identifier of the base station transmitting the scheduling information, beam index, identifier for identifying the scheduling information, radio resource allocation information, MCS information, and resource allocation information for transmission of feedback information (e.g., ACK or NACK) indicating whether the scheduling information is received. The radio resource allocation information may include frequency domain resource allocation information (e.g., transmission band information, subcarrier allocation information) and/or time domain resource allocation information (e.g., frame index, subframe index, slot index, symbol index, transmission period, transmission timing).

In the random access procedure shown in FIG. 6, the RA MSG3 may include one or more of the following information elements.
Capability of the terminal
Properties of the terminal
Mobility state of the terminal
Location information of the terminal
Reason for attempting the access procedure (e.g., random access procedure)

The reason for attempting the access procedure may be a transmission request of system information according to a request of the terminal, transmission request of downlink data according to update of a firmware or essential software of the terminal, or uplink resource allocation request. The information indicating the reason for attempting the access procedure may be information capable of distinguishing the reason for performing the access procedure. The information capable of distinguishing the reason for performing the access procedure may be as follows.
Uplink resource allocation information
Handover request information or measurement result information
Terminal operation state transition (or, change) request information
Resumption information of a radio channel
Re-establishment information of a radio channel
Information related to beam sweeping, beam reconfiguration, or beam change for beam forming
Information related to physical channel synchronization acquisition
Update information of location information
Mobility state or buffer status report

The terminal in the idle state or inactive state may transmit an uplink SDT packet or signaling message (e.g., MAC layer or RRC layer control message) (e.g., SDT) occurring intermittently in the terminal using the uplink radio resource allocated while performing the 4-step RA procedure of FIG. 6. That is, the uplink SDT operation refers to an operation in which the terminal transmits an SDT packet and the base station receives the SDT packet transmitted by the terminal using an uplink resource.

The terminal (e.g., the terminal operating in the RRC idle state or the RRC inactive state) may transmit the uplink SDT data packet or signaling message by using the 4-step RA procedure shown in FIG. 6. The uplink SDT signaling message may be an MAC signaling message (e.g., MAC layer control message or MAC CE) or an RRC signaling message (e.g., RRC layer control message).

For uplink SDT operation for transmission for an SDT packet occurring in the terminal, the terminal may transmit at least one of the following information to the base station by using the RA MSG3 and/or a control message (e.g., MAC CE or RRC message) first transmitted after the RA MSG3.
Identifier (ID) of the terminal
Information informing an uplink SDT or a request of SDT
Information indicating the size of the uplink data (e.g., length indicator (LI)).
   The information indicating the size of the uplink data may indicate the size of the MAC PDU or RRC message or the number of the MAC PDUs and RRC messages.
Information indicating an uplink signaling message (e.g., uplink bearer message) and/or the size of the uplink signaling message (e.g., LI). The information indicating the size of the uplink signaling message may indicate the size of the MAC PDU or RRC message or the number of the MAC PDUs or RRC messages.
Indicator information indicating a range of the size of the uplink data and/or the size of the uplink signaling message
Logical channel identifier (e.g., LCID) of an uplink data bearer or an uplink signaling bearer
Uplink buffer size information (e.g., BSR)
Information on the size of the uplink SDT packet (e.g., the size of SDT packet)
Control message for connection configuration request
Information requesting uplink radio resource allocation
Measurement result of a radio channel
Information on a desired terminal state after completion of the SDT operation

The base station may separately configure RA occasion (RO) configuration parameter(s) and/or RA MSG1 for intermittently occurring DL SDT operations. The base station may separately configure the RO configuration parameter(s) and/or RA MSG1 according to the size or type (or form) of the downlink SDT packet to be transmitted and/or the channel quality of the radio link. As a method of classifying RA radio resource groups for SDT operations, a method of classifying and configuring indexes of RO and/or RA preambles may be considered. That is, in configuring radio resources of the ROs, the uplink radio resource(s) used for RA procedures not for SDT, and the uplink radio resource(s) used for RA procedures for SDT may be configured differently. In addition, indexes of RA preambles for SDT operation may be differently set. The base station may configure one or more selectable RA preamble (RA MSG1) resource groups according to the size of the downlink SDT and/or the channel quality of the radio link (e.g., path loss, RSRP, or RSRQ, etc.). That the RA radio resources for SDT are configured differently may mean that the terminal transmit the RA preambles or RA payloads by configuring different positions or indices of radio resources in the time domain or frequency domain, indices of RA preambles, transmission timings, or offset values.

When the RA MSG3 of the step S605 includes the above-described terminal identifier, uplink data, or control signaling information, control fields for indicating the property or the length of the uplink data and control signaling information, or whether the corresponding control information is included may be configured in form of a MAC subheader, a MAC header, or a logical channel identifier (e.g., LCID), or a MAC control element (CE).

The base station may transmit scheduling information for DL SDT operation to the terminal within a preconfigured time period (e.g., a preconfigured time window (or period) from the time when step S602 or step S603 is performed). The scheduling information may be transmitted on a physical layer control channel (PDCCH). In this case, a scheduling identifier of the PDCCH may be an RA-RNTI or an RTNI for SDT (e.g., SDT-RNTI). The SDT-RNTI may be used to transmit scheduling information for DL SDT operation. Accordingly, the terminal may obtain the scheduling information from the RA MSG2 receiving using the RA-RNTI and/or the PDCCH or PDSCH received using the SDT-RNTI. That is, the scheduling information for DL SDT operation may be delivered to the terminal using a PDCCH or PDSCH resource. Accordingly, the terminal may receive the downlink SDT packet transmitted by the base station using a downlink radio resource allocated by the corresponding scheduling information. In addition, the terminal may transmit an uplink control/report message for DL SDT operation, HARQ feedback information, and/or an uplink SDT packet occurring in the terminal by using an uplink radio resource allocated by the corresponding scheduling information.

When the RA MSG1 for DL SDT operation is not separately configured, the terminal having transmitted the RA MSG1 may receive the RA response message of the step S604 according to the procedure of FIG. 6. Thereafter, the terminal may transmit the RA MSG3 including the above-described control information for SDT to the base station. The RA MSG3 may include a terminal identifier for SDT, and the terminal identifier for SDT may be an identifier assigned to the terminal to identify the terminal in the inactive state, I-RNTI of the 3GPP NR system, or a terminal identifier in an RRC resume request message (e.g., resumeIdentity, I-RNTI, ShortI-RNTI, etc. of the 3GPP NR system).

As described above, when the terminal transmits the CBRA preamble to start the CBRA procedure in step S602, the base station may transmit, to the terminal, scheduling information of a downlink radio resource so that the terminal can perform the DL SDT reception operation in or after step S605. The downlink scheduling information may be transmitted on a PDCCH or PDSCH. The terminal may receive a downlink SDT packet by using the downlink radio resource addressed by the corresponding downlink scheduling information.

In addition, in the DL SDT operation according to the procedure of FIG. 6, when the DL SDT operation is performed as one-shot transmission, the base station may transmit a one-shot transmission indicator together with the SDT packet. On the other hand, when the DL SDT operation is performed one or more times, the base station may transmit control information (or indicator) indicating the last SDT packet (or SDT termination) together with the SDT packet. Here, the one-shot transmission indicator or control information indicating the last SDT packet (or SDT termination) may be delivered to the terminal in form of a DCI, MAC CE, or RRC message. If the DL SDT operation initiated by the base station is successfully completed, the terminal may transition to the idle state or remain in the inactive state according to configuration (or indication) of the base station.

Downlink SDT Method Using 2-Step RA Procedure

FIG. 7 is a sequence chart illustrating a downlink SDT method based on a 2-step random access procedure according to an exemplary embodiment of the present disclosure.

Referring to FIG. 7, a communication system may include a base station, a terminal, and the like. The base station may be the base station 110-1, 110-2, 110-3, 120-1, or 120-2 shown in FIG. 1, and the terminal may be the terminal 130-1, 130-2, 130-3, 130-4, 130-5, or 130-6 shown in FIG. 1. The base station and the terminal may be configured to be the same or similar to the communication node shown in FIG. 2. A random access procedure may be performed in two steps.

The base station may transmit system information and/or a separate control message including the above-described DL SDT configuration information to the terminal (S701). The terminal may obtain the above-described DL SDT configuration information by receiving the system information and/or control message from the base station. The system information may be common system information used for a plurality of base stations or base station-specific system information (e.g., cell-specific system information). The control message may be a dedicated control message. The control message may be a dedicated control message. Here, the dedicated control message may be a control message for configuring an RRC connection, a control message for releasing an RRC connection, or an RRC state transition control message (e.g., a control message for transition to the inactive state). The DL SDT configuration information may include configuration (or allocation) information of an RA radio resource (e.g., uplink radio resource) for DL SDT operation. The configuration information of the RA radio resource may include one or more of transmission frequency information of the physical layer, system bandwidth information (or BWP configuration information), subcarrier spacing information, beam configuration information according to a beamforming technique (e.g., beam width or beam index), variable radio resource configuration information (e.g., radio resource reference value or offset) in the frequency and/or time domain, and inactive (or unused) radio resource region/period information.

When a packet that meets a condition for being transmitted as DL SDT occurs, the base station may transmit information indicating a DL SDT reception operation to the terminal (or terminal group) (S702). In step S702, the base station may transmit control information indicating a DL SDT reception operation on a PDCCH. Step S702 may be the same as step S602 described with reference to FIG. 6. However, when the PDCCH transmitted by the base station in step S702 includes contention-free RA (e.g., CFRA or PDCCH order based RA) configuration information, in addition to the RA preamble index and PRACH mask index described in step S602, PUSCH configuration information for MSG-A payload transmission may be additionally included in the PDCCH of step S702. The parameters included in the above-described DL SDT configuration information and delivered to the terminal in step S701 may be excluded from the PDCCH in step S702. For example, when an RA preamble index of the CFRA configuration information is delivered to the terminal through the above-described DL SDT configuration information, the RA preamble index may not be delivered on the PDCCH.

Upon receiving the control information indicating the DL SDT reception operation transmitted by the base station in step S702, the terminal may transmit an MSG-A (or, RA MSG-A) to the base station by using the uplink radio resource obtained from the control information received in step S702 and/or the DL SDT configuration information received in step S701 (S703). The MSG-A may include an RA preamble and a terminal identifier (e.g., UE ID, DL SDT scheduling identifier). Here, the UE ID transmitted using the RA MSG-A may be a terminal identifier for SDT operation, and the terminal identifier for SDT operation may be an identifier assigned to the terminal to identify the terminal in the inactive state, I-RNTI of the 3GPP NR system, or a terminal identifier in an RRC resume request message (e.g., resumeIdentity, I-RNTI, ShortI-RNTI, etc. of the 3GPP NR system). In addition, the DL SDT scheduling identifier may be a C-RNTI, CS-RNTI, SDT-RNTI, or SDT C-RNTI pre-assigned to the terminal.

In addition, the MSG-A may further include uplink data and/or control information. The message transmitted by the terminal in step S703 of FIG. 7 may be referred to as the ‘RA MSG-A’ or ‘MSG-A’, and the MSG-A may be distinguished from the RA MSG1 in the 4-step random access procedure of FIG. 6.

The RA MSG-A may include an RA preamble and an RA payload. In the 2-step random access procedure, the RA preamble may be referred to as a ‘2-step-RA preamble’, and in the 2-step random access procedure, the RA payload may be referred to as a ‘2-step-RA payload’. The RA preamble of the RA MSG-A may be selected by the MAC layer of the terminal. The RA payload of the RA-MSG-A may be generated by the MAC layer or the RRC layer. The RA preamble selected by the MAC layer of the terminal and the RA payload generated by the MAC layer or RRC layer of the terminal may be delivered to the physical layer. The RA payload of the RA MSG-A may include one or more among the terminal identifier (e.g., UE ID, DL SDT scheduling identifier), uplink data, and control information. The base station may configure the following RA parameters or configuration information selectively applied according to the size of the downlink SDT and/or the channel quality of the radio link (e.g., path loss, RSRP, or RSRQ, etc.), and the terminal may obtain the information in the step S701 and/or S702.
Group configuration information of one or more MSG-A RA preamble resources according to the size of the SDT packet and/or the channel quality of the radio link, and/or
Group configuration information (e.g., MCS configuration list or range) of one or more MCS levels to be applied to the RA payload according to the size of the SDT packet and/or the channel quality of the radio link

Depending on the size of the downlink SDT packet and/or the channel quality of the radio link, the terminal may select the MSG-A RA preamble and/or an MCS level to be applied to the MSG-A RA payload satisfying the condition. When the MSG-A RA preamble resources and MCSs to be applied to the MSG-A RA payload according to the size of the SDT packet and/or the channel quality of the radio link have a mapping or association relationship, if the terminal select the MSG-A RA preamble satisfying the condition according to the size of the downlink SDT and/or the channel quality of the radio link, the MCS level to be applied to the MSG-A RA payload may be determined according to the selected MSG-A RA preamble.

Information on the selected RA preamble and the generated RA payload may be delivered to the physical layer, and the RA MSG-A including the selected RA preamble and the generated RA payload may be transmitted to the base station (S703). The RA payload of MSG-A may include a terminal identifier (e.g., UE ID, DL SDT scheduling identifier, etc.), uplink data (or SDT packet), a logical channel identifier (LCID) for identifying a bearer (e.g., data radio bearer (DRB) or signaling radio bearer (SRB)) for uplink SDT, or control signaling information. Here, the control signaling information may include a BSR, measurement result information (e.g., quality information), BFR request information, RLF report information, request information of RRC connection setup, request information of RRC connection re-establishment, resume request information, and transmission request information of system information. When the CBRA procedure or the CFRA procedure is performed, the RA payload may include the terminal identifier. The uplink radio resource for transmission of the RA preamble may be configured independently of the uplink radio resource for transmission of the RA payload.

For example, the radio resources configured (or allocated) for the radio access procedure may be non-contiguous in the time domain or frequency domain. Alternatively, the radio resources configured (or allocated) for the radio access procedure may be contiguous in the time domain or frequency domain. The radio resources for the radio access procedure may be radio resources configured (or allocated) in different schemes. Alternatively, the radio resources for the radio access procedure may be radio resources defined by different physical layer channels.

The expression that the radio resources for the radio access procedure are different may mean that one or more among the positions of the radio resources in the time domain or frequency domain, indices of the radio resources, indices of the RA preambles, transmission timings, and offsets are configured differently. The RA preamble or RA payload may be transmitted using different radio resources. For example, the RA preamble may be transmitted on a PRACH, and the RA payload may be transmitted on a physical uplink shared channel (PUSCH).

In order to configure the transmission resource for the RA preamble of the RA MSG-A differently from the transmission resource for the RA payload of the RA MSG-A, the uplink radio resource for transmission of the RA payload of the RA MSG-A (e.g., PUSCH configured for transmission of the RA payload of the RA MSG-A) may be configured to correspond to the RA preamble of the RA MSG-A. That is, a mapping relationship between the uplink radio resource for transmitting the RA preamble of the RA MSG-A and the uplink radio resource for transmitting the RA payload of the RA MSG-A may be configured.

For example, the transmission resource of the RA preamble may be mapped one-to-one with the transmission resource of the RA payload. In this case, one PRACH may be mapped to one PUSCH. Alternatively, a plurality of transmission resources of the RA preamble may be mapped to one transmission resource of the RA payload. In this case, a plurality of PRACHs may be mapped to one PUSCH. Alternatively, one transmission resource of the RA preamble may be mapped to a plurality of transmission resources of the RA payload. In this case, one PRACH may be mapped to a plurality of PUSCHs. In order to improve the reception quality of the RA payload, the RA payload may be repeatedly transmitted. The uplink radio resources for the repetitive transmission of the RA payload may be configured, and the corresponding uplink radio resources may be mapped to the transmission resources of the RA preamble.

For example, when the transmission resource of the RA MSG-A is preconfigured or when the RA preamble of the RA MSG-A is transmitted through a preconfigured region (or group), the base station may configure radio resources for the repetitive transmissions of the RA payload of the RA MSG-A. Therefore, when a coverage expansion function is applied or when a preconfigured reference condition is satisfied, the terminal may select RA preamble resources or RA preamble index for the repetitive transmissions of the RA payload, and may repeatedly transmit the RA payload based on the selected resource or index. The terminal may repeatedly transmit the RA payload using uplink radio resources mapped to the RA preamble index. The uplink radio resources (e.g., repeated radio resources) for transmission of the RA payload may be configured within a preconfigured period in the frequency domain or time domain. Information on a mapping relationship of the uplink radio resources for transmission of the RA MSG-A may be transmitted to the terminal through system information and/or an RRC message.

When the 2-step random access procedure is performed in a non-contention scheme, the transmission resources of the RA preamble and/or the RA payload of the RA MSG-A may be allocated dedicatedly to the terminal. In the CFRA procedure, resource information of the RA preamble configured dedicatedly for the terminal may include an SS/PBCH resource list, a CSI-RS resource list, an SS/PBCH index, a CSI-RS index, an RA preamble index, and the like. The transmission resource of the RA payload of the RA MSG-A may be determined based on the mapping relationship (e.g., one-to-one mapping relationship or many-to-one mapping relationship) between the transmission resource of the RA preamble and the transmission resource of the RA payload. In the CFRA procedure (e.g., 2-step CFRA procedure), the resource information of the RA payload configured dedicatedly for the terminal may include allocation information of an uplink radio resource, beam configuration information, MCS information, etc. for transmission of the RA payload.

In the 2-step RA procedure, the transmission resource of the RA preamble may be contiguous with the transmission resource of the RA payload in the time domain. Alternatively, the transmission resource of the RA preamble and the transmission resource of the RA payload may be allocated within a time window. The terminal performing the 2-step RA procedure may transmit the RA payload using the transmission resource of the RA payload, that is contiguous with the transmission resource of the RA preamble. Alternatively, the terminal may transmit the RA payload using an RA payload transmission resource within a preconfigured time window.

Alternatively, parameter(s) for allocation of the transmission resource of the RA preamble and the transmission resource of the RA payload may include a frequency offset and/or a time offset. Accordingly, the terminal may transmit the RA payload using the radio resource for the RA payload mapped to the RA preamble. Alternatively, the terminal may randomly select one or more radio resources among radio resources configured for transmission of the RA payload, and may transmit the RA payload using the selected radio resource(s).

The RA payload of the RA MSG-A transmitted in step 703 may be configured to be the same or similar to the RA MSG3 transmitted in the step S605 shown in FIG. 6. For example, the RA payload of the RA MSG-A may include one or more among the identifier, capability, property, mobility state, and location information of the terminal, a cause for attempting the access procedure, request information of beam failure recovery, measurement result on a base station (or cell) in the CA environment, request information of activation/deactivation of the CA, BWP switching request information, BWP deactivation/activation request information, uplink data (e.g., SDT packet), size of downlink data (e.g., SDT packet), uplink buffer size information (e.g., BSR), control message for requesting connection configuration, request information of uplink resource allocation, and a measurement result of a radio channel. The control information for uplink/downlink SDT included in the RA MSG3 shown in FIG. 6 may be included in the RA payload of the RA MSG-A in FIG. 7. That is, the terminal may transmit the RA payload including control information for uplink/downlink SDT to the base station. That is, for uplink/downlink SDT, the terminal may transmit information indicating whether the SDT is performed as segmented (or whether the SDT is performed as one-shot transmission) together by using the MSG-A RA payload. Depending on whether the SDT is performed as segmented, the terminal may transmit a separate control message (e.g., MAC layer and/or RRC layer control message) in addition to the SDT. For example, when the segmented transmission of the SDT is applied, the terminal may deliver one or more among uplink radio resource request information for the transmission of segmented SDTs and/or the size of the uplink/downlink SDT (e.g., the size of the MAC PDU or RRC message, etc.), the number of messages for the uplink/downlink SDT (e.g., the number of the MAC PDUs or RRC messages, etc.), uplink buffer size information (e.g., BSR), a control message for connection configuration request, information such as a radio channel measurement result, or a desired operation state of the terminal after completion of the SDT. When the control information is transmitted as a MAC layer message, whether the corresponding control information exists and/or value(s) (or configuration parameter range(s)) of the control information may be delivered in form of a MAC (sub)header or a MAC (sub)PDU. For this, a separate logical channel identifier (LCID) may be configured.

When the terminal identifier, uplink data, or control signaling information is transmitted in step S703 through the radio resource for transmission of the MSG-A RA payload together with the RA preamble, control fields indicating the property or length of the corresponding uplink data and the corresponding control signaling information or information whether the corresponding control information is included may be configured in form of a MAC header, logical channel identifier (e.g., LCID), or MAC CE.

In the step S703, for transmission timing adjustment (e.g., timing advance (TA)) or transmission power control of the terminal, the terminal may transmit the RA payload of the MSG-A by inserting a preamble, pilot symbol, or reference signal (e.g., RS) in a first symbol or some symbols constituting the RA payload of the MSG-A.

The base station receiving the identifier of the terminal and uplink data or control signaling information transmitted by the terminal through the MSG-A of step S703 may generate and transmit an RA response message (hereinafter, RA MSG-B or MSG-B) (S704). The RA MSG-B may include a backoff indicator (BI), uplink radio resource allocation information, information indicating the RA preamble of the received RA MSG-A, transmission timing adjustment (TA) information of the terminal, scheduling identifier (C-RNTI or Temporary C-RNTI, etc.), and/or a terminal identifier (hereinafter referred to as a contention resolution ID (CRID)) for contention resolution.

If the CFRA-based RA procedure is performed in step S703, a DL SDT packet may be transmitted to the terminal together with the MSG-B in step S704, or a DL SDT packet may be transmitted to the terminal through a PDSCH resource indicated by scheduling information (e.g., PDCCH or DCI) for DL SDT operation addressed using a pre-assigned DL SDT scheduling identifier (e.g., C-RNTI, CS-RNTI, SDT-RNTI, SDT C-RNTI, etc.).

When the CRID transmitted through the MSG-A is included in the MSG-B received by the terminal in step S703, the base station and the terminal may determine that the contention is resolved. In particular, if the MSG-B (i.e., RA response) including TA information or uplink grant information and DL SDT packet are received within an RA response window (or before a related timer expires), or if scheduling information of a PDSCH is received from the base station by using a C-RNTI, the terminal may determine that contention resolution for the MSG-A transmitted by the terminal has been completed.

The PDCCH (or DCI) transmitted using the pre-assigned DL SDT scheduling identifier in step S703 may include downlink resource allocation information (e.g., scheduling information), transmission timing adjustment information (e.g., TA value or TAC), transmission power adjustment information, beam configuration information or TCI state information, CS state information, and/or PUCCH configuration information. Here, the beam configuration information may be information indicating activation or deactivation of a specific beam. The TCI state information may be information indicating activation or deactivation of a specific TCI state. The CS state information or configured grant (CG) (or SPS) state information may be information indicating activation or deactivation of a radio resource allocated in the CS scheme. The state transition information may be information indicating transition of the operation state of the terminal shown in FIG. 5. The state transition information may indicate transition from a specific operation state to the RRC idle state, the RRC connected state, or the RRC inactive state. Alternatively, the state transition information may indicate maintaining of the current operation state. The PUCCH configuration information may be allocation information of a scheduling request (SR) resource. Alternatively, the PUCCH configuration information may be information indicating activation or deactivation of an SR resource.

The information not included in the DCI among the above-described information may be transmitted on a PDSCH addressed by downlink resource allocation information (e.g., scheduling information) transmitted through the DCI, and the downlink SDT packet may be transmitted on the PDSCH.

In addition, when a scheduling identifier (e.g., C-RNTI or SDT C-RNTI, etc.) for DL SDT operation is dedicatedly assigned to the terminal using the DL SDT configuration information, the PDCCH may be transmitted using the pre-assigned scheduling identifier. In this case, the terminal may perform the DL SDT reception operation. That is, the PDCCH of step S704 may be received using the pre-assigned scheduling identifier for DL SDT operation, and the DL SDT packet may be received on a PDSCH addressed by the PDCCH. The terminal may also receive a DL SDT packet by using a PDSCH addressed by DCI transmitted using the corresponding scheduling identifier thereafter.

However, when the CBRA-based RA procedure is started in step S703, the base station may address the PDSCH for carrying the RA MSG2 (or RA response message) by the PDCCH (or DCI) for the RA response in step S704. The RA response message transmitted on the PDSCH may include at least one of the CRID, transmission timing adjustment information (e.g., TA value or TAC), transmission power adjustment information, backoff information, information on the index of the RA preamble received in step S703, or scheduling identifier (e.g., C-RNTI) assigned to the terminal. The control information not included in the RA response message may include one or more of beam configuration information or TCI state information, configured scheduling (CS) state information, state transition information, or PUCCH configuration information. The control information not included in the RA response message may be transmitted using a PDSCH in form of a MAC CE or may be transmitted using a PDCCH at every DL SDT operation.

In addition, when the DL SDT operation is performed as one-shot transmission, the base station may transmit a one-shot transmission indicator together with the SDT packet in step S704. In addition, when the DL SDT operation is performed one or more times, the base station may transmit control information (or indicator) indicating the last SDT packet (or SDT termination) together with the SDT packet. Here, the one-shot transmission indicator or control information indicating the last SDT packet (or SDT termination) may be delivered to the terminal in form of a DCI, MAC CE, or RRC message. If the DL SDT operation initiated by the base station is successfully completed in step S704, the terminal may transition to the idle state or remain in the inactive state according to configuration (or indication) of the base station.

When the terminal receives only the above-described RA response message (i.e., MSG-B) without the DL SDT packet from the base station in step S704, the 2-step RA procedure for DL SDT operation may be completed in step S704. The base station that has successfully completed the 2-step RA procedure may transmit a DL SDT packet and/or a control message using the scheduling identifier assigned to the terminal (S705). That is, from step S704 and/or step S705, the base station may transmit scheduling information of a downlink radio resource to the terminal so that the terminal can perform a DL SDT reception operation. The base station may transmit the downlink scheduling information using the scheduling identifier assigned to the terminal. The terminal may receive a downlink SDT packet by using the downlink radio resource (or PDSCH) addressed by the downlink scheduling information. If the DL SDT operation initiated by the base station is successfully completed in step S705, the terminal may transition to the idle state or remain in the inactive state according to configuration (or indication) of the base station.

On the other hand, in the step 4 RA procedure, the RA response window may start at a time when the transmission of the RA MSG1 is completed, and in the step 2 RA procedure, the RA response window may start at a time when the transmission of the RA payload of the RA MSG-A is completed. Therefore, if the terminal does not receive the MSG-B (i.e., RA response) including TA information or uplink grant information scheduled by the C-RNTI within the RA response window (or before a related timer expires), the terminal may determine that contention resolution for the 2-step RA procedure according to the MSG-A transmitted by the terminal has failed. When the MSG-B scheduled by the C-RNTI is transmitted in response to the 2-step RA procedure according to the MSG-A transmitted by the terminal, a PDCCH (e.g., DCI or UCI) including an indicator indicating that it includes scheduling information of the RA response for the MSG-A together with TA information may be transmitted.

The RA MSG-B may be generated in form of a MAC control message (e.g., MAC CE) of the MAC layer of the base station and/or in form of an RRC control message of the RRC layer of the base station. When the RA MSG-B is generated in form of a MAC CE, the RRC layer, which has received information on the received RA MSG-A, may deliver control parameters to be included in the RA MSG-B to the MAC layer, and the MAC layer may generate (or configure) the MSG-B in form of a MAC CE. In step S704, the base station may transmit the MSG-B including the identifier of the terminal received through the RA payload of MSG-A.

When the RA preamble of the RA MSG-A is dedicatedly allocated to the terminal, or when the radio resource for transmission of the RA preamble of the RA MSG-A and the RA payload has a predetermined mapping relationship, the RA response message of step S704 may not include information on the index of the RA preamble transmitted by the terminal.

When the RA preamble of the RA MSG-A is assigned dedicatedly to the terminal or the RA payload including the scheduling identifier (e.g., C-RNTI) assigned to the terminal is received, the base station may transmit scheduling information (e.g., PDCCH) of a physical layer radio resource for transmission of the MSG-B by using the scheduling identifier.

In step S704, the base station may transmit only the PDCCH for allocating an uplink radio resource, transmit only the PDCCH (e.g., DCI form) for the RA response, or transmit the RA response message on the PDSCH. When the base station transmits only the PDCCH for allocating an uplink radio resource in step S704, the corresponding DCI may include one or more among uplink resource allocation information (e.g., scheduling information), transmission timing adjustment information (e.g., TA value or TAC), transmission power adjustment information, backoff information, beam configuration information or TCI state information, configured scheduling (CS) state information, state transition information, PUCCH configuration information, information on the index of the RA preamble of the MSG-A received in step S703, or uplink resource allocation information for transmission of the RA payload of the MSG-A. Here, the beam configuration information may be information indicating activation or deactivation of a specific beam. The TCI state information may be information indicating activation or deactivation of a specific TCI state. The CS state information or configured grant (CG) (or SPS) state information may be information indicating activation or deactivation of a radio resource allocated in the CS scheme. The state transition information may be information indicating transition of the operation state of the terminal shown in FIG. 5. The state transition information may indicate transition from a specific operation state to the RRC idle state, the RRC connected state, or the RRC inactive state. Alternatively, the state transition information may indicate maintaining of the current operation state. The PUCCH configuration information may be allocation information of a scheduling request (SR) resource. Alternatively, the PUCCH configuration information may be information indicating activation or deactivation of an SR resource.

The base station may transmit only the PDCCH described above and transmit the control information in step S704 using a PDSCH radio resource. That is, the base station may generate and transmit a control message including the uplink radio resource allocation (or scheduling) information, transmission timing adjustment information, transmission power adjustment information, backoff information, beam configuration information or TCI state information, CS state information, state transition information, PUCCH configuration information, and/or information on the index of the RA preamble of the MSG-A transmitted by the terminal in step S703.

The base station may transmit only the PDCCH for the RA response in step S704. In this case, the control information may be transmitted on the PDSCH. That is, the control information may include one or more of the uplink radio resource allocation (or scheduling) information, transmission timing adjustment information (e.g., TA value or TAC), transmission power adjustment information, backoff information, beam configuration information or TCI state information, CS state information, state transition information, PUCCH configuration information, and/or information on the index of the RA preamble of the MSG-A received in step S703.

For the generation and transmission of the MSG-B in step S704, the base station may transmit the PDCCH including scheduling information for the transmission of the MSG-B by using the RA-RNTI or the scheduling identifier (C-RNTI) assigned to the terminal. The RA response message (i.e., MSG-B) may be transmitted using the PDSCH resource addressed by the scheduling information in the PDCCH.

RA radio resources may be configured separately as RA radio resources for the RA procedure not for SDT, and RA radio resources for the RA procedure for SDT. In the above-described two types of RA procedures, RA radio resources for the 2-step RA procedure and/or the 4-step RA procedure may be separately configured. When performing an uplink SDT by using the RA procedure, in consideration of the above-described radio channel quality condition, whether the uplink physical layer synchronization is maintained, the size condition of the SDT, whether the SDT is performed as segmented, and/or RA radio resource configuration (e.g., RO, RA preamble group, RA-MSG3, RA payload size of MSG-A, etc.), the terminal may determine which RA procedure to perform according to the following methods.

Method 1:
First step: The terminal selects one of an RA procedure not for SDT and an RA procedure for SDT.
Second step: The terminal selects the 2-step RA procedure or the 4-step RA procedure for the RA procedure selected in the first step.

Method 2:
First step: The terminal selects the 2-step RA procedure or the 4-step RA procedure as an RA type for SDT.
Second step: For the RA type selected in the first step, the terminal selects one of an RA procedure not for SDT and an RA procedure for SDT.

Method 3: The Terminal Select One Among the Follows Four Procedure.
The 2-step RA procedure not for SDT
The 4-step RA procedure not for SDT
The 2-step RA procedure for SDT
The 4-step RA procedure for SDT

Downlink SDT Method Using SPS Resources

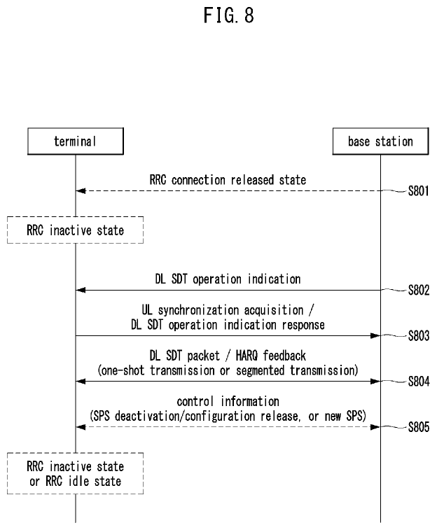

FIG. 8 is a sequence chart illustrating a downlink SDT method based on SPS resources according to an exemplary embodiment of the present disclosure.

After terminating the service in the RRC connected state with the base station, the terminal may transition to the RRC inactive state (S801). In step S801, the terminal may receive a part (or all) of the DL SDT configuration information described above with reference to FIG. 6 or 7 by using an RRC connection release message transmitted by the base station.

When a packet that meets a condition for being transmitted as DT SDT occurs, the base station may transmit information indicating a DL SDT reception operation to the corresponding terminal (or terminal group) (S802). In order to receive the information indicating a DL SDT reception operation transmitted by the base station in step S802, the terminal may perform a PDCCH monitoring operation in a monitoring time region according to an SPS periodicity or a DRX operation cycle obtained from the above-described DL SDT configuration information. The SPS periodicity and/or the DRX operation cycle may be allocated to terminals supporting DL SDT operation uniquely or dedicatedly in the time domain and/or the frequency domain. That is, according to the SPS periodicity and/or the DRX operation cycle, a terminal that needs to receive the information indicating the DL SDT reception operation by performing the PDCCH monitoring operation in step S802 may be designated. Accordingly, the base station initiating the DL SDT operation may identify a terminal to receive the information indicating the SDT reception operation at the corresponding monitoring time point. In addition, the terminal performing downlink monitoring at the corresponding monitoring time point may also recognize that the information indicating the SDT reception operation is transmitted to the terminal itself. To this end, the SPS periodicity and/or the DRX operation cycle for DL SDT operation may be configured to be distinguished for each terminal in the time domain.

The base station may transmit control information indicating the DL SDT reception operation on a PDCCH. In this case, the PDCCH may be transmitted using a paging scheduling identifier (e.g., P-RNTI), a paging scheduling identifier for SDT (e.g., SDT P-RNTI), or a scheduling identifier (e.g., C-RNTI, CS-RNTI, SDT-RNTI, or SDT C-RNTI, etc.) pre-assigned to the terminal (or terminal group) based on the above-described DL SDT configuration information. That is, CRC bits of the PDCCH may be transmitted as being scrambled by the corresponding scheduling identifier.

The PDCCH transmitted by the base station in step S802 to indicate the DL SDT reception operation may include one or more of the following information elements.
DL SDT reception operation execution indicator
CFRA configuration information (e.g., RA preamble index, PRACH mask index, etc.)
DL SDT operation BWP index
Scheduling identifier for DL SDT operation
DL SDT execution scheme indicator (or indication information)
DL SDT validity timer
DL SDT one-shot transmission indicator
SPS activation indication information

However, when some of the above-described parameters are delivered to the terminal as being included in the above-described DL SDT configuration information, the PDCCH may not include the corresponding parameter(s). For example, when the scheduling identifier for DL SDT operation is delivered to the terminal as being included in the above-described DL SDT configuration information, the information on the scheduling identifier for DL SDT operation may not be included in the PDCCH. That is, when the scheduling identifier (e.g., C-RNTI, CS-RNTI, SDT-RNTI, SDT C-RNTI, etc.) for DL SDT operation is pre-assigned to the terminal (or terminal group) using the DL SDT configuration information, the PDCCH of step S802 may be transmitted using the scheduling identifier assigned by the DL SDT configuration information. On the other hand, when the scheduling identifier for DL SDT operation is not pre-assigned by the DL SDT configuration information to the terminal (or terminal group), the PDCCH (e.g., DCI or SMS) in step S802 may be transmitted using a paging scheduling identifier or a paging scheduling identifier for SDT.

The SPS activation indication information may be information indicating activation of a specific SPS resource when a plurality of SPS resources are configured for DL SDT operation. When the SPS activation indication information is not transmitted on the PDCCH (or DCI), the SPS activation indication information may be transmitted to the terminal in form of a MAC CE or RRC control message using a downlink radio resource (e.g., PDSCH) in step S802 or a downlink radio resource (e.g., PDSCH) transmitted by the base station first after step S802.

When one or more among the DL SDT configuration information are transmitted from the base station to the terminal, the terminal in the inactive or idle state may perform a DL SDT reception operation using the downlink SPS resource even when uplink synchronization is not maintained with the base station.

In order for the terminal in the inactive state or idle state in which uplink synchronization is not maintained to perform a DL SDT reception operation using the SPS resource, information indicating that an operation (or procedure) for maintaining uplink synchronization is not required or that uplink synchronization (or TA synchronization) is valid may be configured based on a service coverage size of the base station, uplink synchronization maintenance timer of the terminal (or HARQ feedback information of the terminal for downlink SDT reception, or a separate timer for determining whether the uplink transmission of the terminal is allowed), channel quality of a radio link, location information of the terminal, and/or the like. For example, when there is no need for compensation for a path delay or uplink synchronization (or TA synchronization) is always valid according to the service coverage size of the base station, the SPS resource-based DL SDT reception operation (downlink SDT reception and/or uplink transmission operation of the terminal) may be allowed. For example, the uplink synchronization maintenance timer of the terminal may be a separate timer for determining whether the DL SDT reception operation using the SPS resource is allowed, and when the uplink synchronization maintenance timer satisfies a reference condition (or value), the DL SDT reception operation using the SPS resource may be allowed. For example, when it is determined that a distance between the terminal and the base station is a distance that does not require compensation for a path delay based on the location information of the terminal, the SPS resource-based DL SDT reception operation may be allowed because the TA synchronization (or uplink synchronization) is valid regardless of whether the TA is maintained or not. Here, the location information of the terminal may mean information on a geographic location of the terminal or a relative location of the terminal within the coverage of the base station, which is estimated (or measured) by the terminal based on a location estimation algorithm, a GPS function, a built-in sensor, and/or the like.

In addition, when a channel quality of a radio link between the serving or camped base station and the terminal satisfies a predefined reference condition (or value), it may be determined that the distance between the terminal and the base station is a distance that does not require compensation for a path delay or a distance that TA synchronization (or uplink synchronization) is valid. Therefore, in this case, the SPS resource-based DL SDT reception operation may be allowed. Here, the reference condition for the channel quality of the radio link may be a case in which one or more of the following parameters are satisfied.
When a channel quality of a radio link is higher than a reference value
When a channel quality remains above a reference value until a predetermined timer expires or for a predetermined time window
When a change or variation range of a channel quality of a radio link is equal to or higher than a reference value
When a change or variation range of a channel quality satisfies a reference condition until a predetermined timer expires or for a predetermined time window

That is, when the terminal in the inactive state or idle state, for which SPS resource(s) are configured, maintains uplink synchronization or uplink transmission thereof is allowed, the base station may transmit, to the terminal (or terminal group), information indicating activation of an SPS resource in step S802. When the SPS activation indication information is received in step S802, the terminal maintaining uplink synchronization or allowed to perform uplink transmission according to the above-described method may transmit response information, HARQ feedback information, and/or beam pairing information therefor (S803). Here, the information indicating activation of the SPS resource may be transmitted on a PDCCH, and the PDCCH may be transmitted using a scheduling identifier pre-assigned to the terminal (or terminal group), a scheduling identifier assigned for activation indication of an SPS resource for downlink SDT transmission, a paging identifier, or a paging identifier for downlink SDT. In this case, the PDCCH may be configured by including one or more of the following parameters.
SPS activation indicator,
SPS resource configuration information (e.g., SPS allocation periodicity, SPS start time information, SPS end time information, and/or SPS validity timer, etc.)
Uplink resource configuration information (e.g., BWP index, frequency/time domain allocation information, etc.) for HARQ feedback transmission indicating whether SPS reception is successful
DL SDT operation BWP configuration information (e.g., frequency domain allocation information, BWP index information, etc.)

However, when some of the above-described parameters are delivered to the terminal, the PDCCH may not include the corresponding parameter(s) as being included in the above-described DL SDT configuration information and. For example, when the SPS resource configuration information is delivered to the terminal as being included in the above-described DL SDT configuration information, the PDCCH may not include the SPS resource configuration information.

In addition, the case where uplink transmission is allowed may mean a case of setting a timer for determining whether uplink synchronization is maintained to infinity, a case where transmission timing adjustment information for maintaining uplink synchronization of the terminal is not required, a case where the base station explicitly indicate, to the terminal, indication information allowing HARQ feedback information transmission of the terminal for the downlink SDT reception or uplink transmission of the terminal through system information and/or a separate dedicated control message, or a case where the terminal can recognize that HARQ feedback information transmission of the terminal for the downlink SDT reception or uplink transmission of the terminal is allowed. In addition, the beam pairing information may mean index information, or the like for identifying a TCI state of a base station transmission beam received by the terminal, a beam of SSB and/or CSI-RS (or a reference signal for downlink beam identification for SPS reception), or the like.

Upon receiving the response information, HARQ feedback information, and/or beam pairing information corresponding to the SPS activation indication from the terminal, the base station may transmit a downlink SDT packet through the activated SPS resource.

The terminal may receive the downlink SDT packet using the activated SPS resource. That is, the terminal in the inactive/idle state may perform the DL SDT reception operation with the SPS resource allocated according to the SPS configuration information for DL SDT operation. The base station and the terminal may perform the DL SDT operation using the SPS resource delivered by the DL SDT configuration information and/or PDCCH.

In the method of performing the SPS resource-based downlink SDT operation, the above-described step of transmitting the SPS activation indication information of the base station and transmitting the response information of the terminal may be omitted, and the base station may transmit the downlink SDT using an SPS resource. In this case, the base station may transmit a PDCCH (or DCI information) for each transmitted SPS resource. That is, the terminal in the inactive/idle state may perform a PDCCH monitoring operation according to the SPS configuration information for DL SDT and receive a downlink SDT through an SPS resource addressed by the corresponding DCI. Accordingly, a scheduling identifier for monitoring a PDCCH indicating reception in the SPS resource (e.g., CS-RNTI or a scheduling identifier configured for downlink SDT reception) may be pre-assigned to the terminal (or terminal group).

The information indicating whether the above-described SPS resource-based DL SDT operation is allowed and/or information on a reference value (or threshold) for determining whether the SPS resource-based DL SDT operation is possible may be obtained through the DL SDT configuration information or PDCCH. Even when the terminal obtaining the above-described information is a terminal in the inactive or idle state or a terminal that does not maintain uplink synchronization, the terminal may perform the SPS resource-based DL SDT reception operation if the reference condition is satisfied according to the obtained information.

In addition, when a predetermined uplink synchronization maintenance timer (e.g., a separate timer for determining whether an SPS resource-based DL SDT operation is allowed) does not expire from a time point at which the terminal receives a message indicating transition from the RRC connected state to the RRC inactive state, a last reception time of uplink transmission timing adjustment information (i.e., TA information), a last reception time from the base station, or a last transmission time of the terminal, the terminal may determine that compensation for a path delay with the base station is not necessary or that TA synchronization (or UL synchronization) is valid, and may perform the SPS resource-based DL SDT reception operation.

In addition, when satisfying one or more conditions or a selective combination of one or more conditions among the service coverage size of the base station, uplink synchronization maintenance timer (e.g., a separate timer for determining whether an SPS resource-based DL SDT operation is allowed) of the terminal, validity of the configured SPS resource, channel quality of the radio link, size of the SDT, and/or location information of the terminal, the terminal may be controlled to perform the SPS resource-based DL SDT operation.

When the uplink synchronization (re)configuration of the terminal is required, the base station may use the above-described RA procedure in step S802 or may transmit uplink resource allocation information for uplink synchronization acquisition in step S802. Here, the uplink resource for uplink synchronization acquisition may be configuration information for an RA radio resource, scheduling request (SR) resource, or reference signal resource capable of acquiring uplink synchronization (or TA acquisition/adjustment).

According to the method of configuring the SPS periodicity and/or the DRX operation cycle for DL SDT operation differently for each terminal in the time domain, which was described in step S802, the base station initiating the DL SDT operation may identify the terminal receiving the information indicating the SDT reception operation at the corresponding monitoring time point. In addition, the terminal performing downlink monitoring at the corresponding monitoring time point may also recognize that the information indicating the SDT reception operation is transmitted to the terminal. Accordingly, the uplink resource (e.g., RA radio resource, SR resource, or uplink reference signal (UL RS) resource, etc.) allocated for the purpose of uplink synchronization acquisition may be a radio resource dedicatedly allocated to the terminal within a preconfigured time region (or, timer or window) allowed for uplink synchronization acquisition for DL SDT operation.

Accordingly, the uplink resource (e.g., RA radio resource, SR resource, or UL RS resource) allocated by the base station for the purpose of uplink synchronization acquisition of the terminal in step S802 may be a radio resource dedicatedly allocated to the terminal within the preconfigured time region (or, timer or window) allowed for uplink synchronization acquisition for DL SDT operation. That is, the RA radio resource may be an RA preamble and/or PUSCH resource for MSG-A transmission allocated in the above-described CFRA scheme (or PDCCH order scheme). In addition, when dedicatedly allocating to the corresponding terminal, the base station may transmit radio resource allocation information and/or identifier information for identifying the SR resource or the UL RS resource to the terminal by using the PDCCH and/or PDSCH of step S802. Accordingly, the RA resource, the SR resource, or the UL RS resource, which are dedicatedly allocated to the terminal receiving the DL SDT operation indication message in step S802, may be allocated dedicatedly to the terminal for a predetermined time (e.g., timer or window). If the above-described DL SDT configuration information includes information on the uplink radio resource for uplink synchronization acquisition, the information indicating the DL SDT reception operation in step S802 may be a message indicating to perform uplink synchronization acquisition using the radio resource allocated in advance using the DL SDT configuration information message without the allocation information of the radio resource for uplink synchronization acquisition.

The terminal receiving the uplink radio resource allocation information for synchronization acquisition and/or indicated to perform an uplink synchronization acquisition operation in step S802 may transmit an uplink signal/message for synchronization acquisition and/or a response message to the DL SDT reception operation indication (S803).

The base station receiving the uplink signal/message (e.g., SR resource, UL RS, RA preamble, and/or MSG-A, etc.) for synchronization acquisition in step S803 may transmit, to the terminal, TA information for uplink synchronization configuration (or adjustment) and/or a DL SDT packet (S804). Upon receiving the TA information and/or the DL SDT packet from the base station in step S804, the terminal may transmit HARQ feedback information and/or control information for the received DL SDT packet through uplink (S805). Here, the control information may indicate a measurement result of the radio channel quality, CQI for downlink scheduling, information on uplink data occurrence (e.g., BSR, uplink SDT request, etc.), assistant information of the terminal, preference information of the terminal, and/or the like.

When the DL SDT operation is performed as one-shot transmission in step S804, the base station may transmit a one-shot transmission indicator together with the SDT packet. Alternatively, when the DL SDT operation is performed one or more times, the base station may transmit control information (or indicator) indicating the last SDT packet (or SDT termination) together with the SDT packet. Here, the one-shot transmission indicator or control information indicating the last SDT packet (or SDT termination) may be delivered to the terminal in form of a DCI, MAC CE, or RRC message.

If the DL SDT operation initiated by the base station is successfully completed, the terminal may transition to the RRC idle state or remain in the RRC inactive state according to configuration (or indication) of the base station (S805).

For the DL SDT operation, the base station may transmit, to the terminal, configuration information (i.e., SPS configuration information) of PDSCH resource(s) allocated to the terminal (or terminal group) in the SPS scheme by using system information or a dedicated control message. Here, the dedicated control message may be a control message for RRC connection configuration, a control message for RRC connection release, or an RRC state transition control message (e.g., a control message for transition to the inactive state).

The SPS configuration information for DL SDT operation may be applied or valid only for a base station that has configured (or signaled) the corresponding SPS configuration information. Accordingly, the base station may transmit SPS configuration information of neighboring base station(s) to the terminal through system information. The SPS configuration information of the neighboring base station(s) included in the system information may be configured in form of a list consisting of SPS configuration(s) of one or more neighboring base station(s).

When the terminal in the inactive state moves from the base station to which the received SPS configuration information is applied to another base station, the terminal may obtain SPS configuration information again from a new base station. To this end, the terminal may perform a procedure of obtaining SPS configuration information whenever it enters a new base station, or may obtain the SPS configuration information of the new base station using system information. Alternatively, the terminal may obtain the SPS configuration information of the corresponding base station when performing a resume procedure (e.g., a timer-based resume procedure or a resume procedure according to a resume procedure execution condition such as a routing area update condition, etc.) that meets an execution condition other than the SDT purpose.

Even when the terminal in the inactive state enters a new base station, as described above, if the SPS configuration information is configured in form of a list of SPS configuration(s) for one or more base station(s), the terminal may perform a DL SDT reception operation according to indication of the new base station, which is in accordance with the above-described method, based on the SPS configuration information corresponding to the new base station in the list of SPS configuration(s).

Alternatively, SPS resource(s) applicable to a plurality of base stations may be configured for the terminal in the inactive state. To this end, the base station may configure (or designate) downlink, BWP, and/or CORESET resource(s) for SPS resource(s) shared or partially overlapped with an adjacent base station. In this manner, shared or partially overlapped SPS resource(s) (e.g., DL, BWP, or CORESET resource(s), etc.) may be configured for DL SDT operation between a plurality of base stations. Hereinafter, the SPS resource(s) shared or partially overlapped between the plurality of base stations will be referred to as ‘shared SPS resource(s)’ or ‘common SPS resource(s)’. Common SPS configuration information delivered to the terminal may be configured to include an indicator or identifier by which the inactive terminal entering a new base station can determine whether a shared SPS resource configured from a previous base station is valid (or whether the shared SPS resource can be used). In this manner, when shared SPS resource(s) are configured for a plurality of base stations, if a shared SPS resource configured with a previous base station is valid, the inactive terminal entering the new base station may perform a DL SDT reception operation by using the shared SPS resource according to the SPS configuration information. If a shared SPS resource configured from a previous base station is not valid, the inactive terminal entering the new base station may obtain SPS configuration information for the new base station by using a resume procedure or a separate SPS configuration (or SDT request) procedure.

In order for the inactive terminal entering the new base station to obtain an SPS resource, the base station may transmit SPS configuration information to the terminal using system information or may configure an uplink radio resource for triggering (or initiating) an SPS configuration procedure to the terminal. Accordingly, the inactive terminal entering the new base station may obtain SPS configuration information by using the corresponding radio resource without transitioning to the connected state.

The above-described SPS configuration information for DL SDT operation may be allocated to the terminal by using a control message in a connection setup step or a connection resume step, or a control message for state transition (or connection release). In addition, the SPS resource may be a channel (or radio resource) allocated to a terminal (or terminal group) existing (or located) in a service area that satisfies a preconfigured condition.

The above-described SPS configuration information for DL SDT operation may include SPS resource allocation information (a bit string and/or PDSCH for SPS resource transmission), MCS information, HARQ configuration information, reception timing (or window), or information for SPS resource mapping between base stations in the SPS resource area. Here, the SPS resource allocation information may include the identifier of the terminal or terminal group to which the SPS resource is allocated (or configured), whether the SPS resource is allocated one-time, whether the SPS resource is repeatedly allocated, and/or the number of times that the SPS resource is repeatedly allocated.

In addition, the SPS resource allocation information may refer to allocation information of a physical layer radio resource (e.g., physical resource block (PRB)) constituting the SPS resource in the time domain and/or the frequency domain. The SPS resource allocation information may include an index of a subcarrier where the SPS resource starts in the frequency domain (e.g., system bandwidth, BWP, or subcarrier, etc.) or an offset from a predetermined reference (e.g., a start point of subcarriers constituting a system bandwidth or a BWP), a BWP index of the SPS resource, information on the number of subcarriers or subchannels of the SPS resource, and the like. Here, the BWP index of the SPS resource may be an indicator for identifying a BWP in which the SPS resource is configured and/or a BWP configured for SDT. The base station may configure or designate one or more BWP(s) for DL SDT packet transmission. When the BWP index is delivered to the terminal using system information or a control message for connection configuration, the BWP index information may be excluded from the SPS resource allocation information. The SPS resource allocation information may include an index of a start position of the SPS resource (e.g., an index of a frame, subframe, slot, mini-slot, or symbol where the SPS resource starts) in the time domain (e.g., frame, subframe, slot, mini-slot, symbol, etc.) and/or the length of the SPS resource, SPS resource allocation periodicity, a period (duration, window, or timer) in which the allocated SPS resource is valid, or transmission-possible period information. Here, the SPS resource allocation periodicity may be configured in units of radio frames, subframes, slots, mini-slots, or symbols. In addition, the SPS resource allocation periodicity may be indicated by a frame and/or subframe in which the SPS resource is transmitted, which is determined based on a modulo operation using the identifier of the terminal (e.g., IMSI, TMSI, S-TMSI, ResumeID, I-RNTI, C-RNTI, or other terminal identifiers) and/or a system frame number (SFN). A start point of slots, mini-slots, or symbols in the corresponding frame and/or subframe may be indicated by using offset information or offset information for the position where the SPS resource starts.

In addition, a date and time (e.g., year/month/day/time) when a DL SDT operation is required may be specified, or a period for the date and time when a DL SDT operation is required may be designated. In this case, the SPS resource for SDT may be configured on a specific month every year and/or on a specific date (or date range) every month. Alternatively, the SPS resource for DL SDT operation may be configured at a specific time (or time range) of a specified year, month, and day. The specific date and time may be configured based on time information such as a UTC, GPS, or the like.

The MCS information represents information on a modulation scheme and code rate applied when performing the DL SDT operation using the SPS resource. The MCS information may be configured in form of a list or range having one or more MCS values. The terminal may select an MCS value that satisfies a condition from the MCS list (or range) according to the size of the SDT to be performed and/or the measurement result of the channel quality (e.g., CSI level, RSRP, RSRQ, etc.). When the terminal is configured to perform the SDT by selecting an MCS value, or when the base station does not deliver information on the MCS to be applied to the SPS resource to the terminal, the base station may transmit information on the MCS applied to the SPS resource (e.g., SPS resource MCS indicator) to the terminal by using a PDCCH (or DCI) at a time point of transmitting a DL SDT packet.

In addition, the transmission timing information may refer to a system frame number (SFN) of the SPS resource for SDT, index of the frame/subframe/slot/mini-slot/symbol, offset information for the SFN/frame/subframe/slot/mini-slot/symbol, etc. that can be used for estimating a transmission time (or timing), a time window value, or the like. The transmission timing information may include a start point where the SPS resource starts in the time domain (e.g., frame, sub-frame, slot, or mini-slot, symbol, etc.) or information on an offset from a predetermined reference (e.g., a time reference point configured with an SFN or an index of frame/subframe, etc.). That is, the offset information may be offset information (e.g., in units of radio frames, subframes, slots, mini-slots, or symbols) from a start point of the SPS resource allocation periodicity or a reference point of the SFN.

In addition, the HARQ configuration information may include information indicating whether a HARQ function is supported for the DL SDT operation and/or whether repetitive transmission is applied to the DL SDT operation, the number of repetitions, configuration information of the SPS resource to which repetitive transmission is applied, information on a time period to which the repetitive transmission is applied, or the like.

In addition, the information for SPS resource mapping between the base stations in the SPS resource area (hereinafter, SPS resource mapping information) may refer to information for mapping SPS resource(s) between base stations belonging to the same area when the SPS configuration information includes information on shared SPS resource(s) commonly applied to one or more base station(s). For example, the mapping information may, even when different numerologies are applied to the base stations belonging to the area in which the same SPS configuration information is applied (or, the area to which the SPS configuration information having the same area identifier is applied), refer to information for the terminal to recognize an SPS resource and/or a shared SPS resource of a new base station according to the SPS configuration information. Therefore, the mapping information may include offset information or information on a conversion mapping rule between different numerologies, which is used for acquiring SPS configuration information to be actually applied to each of the base stations to which numerologies different with respect to transmission frequency/bandwidth, BWP configuration, subcarrier spacing, symbol length, or the like are applied. For example, when a BWP in which the SPS resource obtained from the previous base station is configured and a BWP of a new base station are different in subcarrier spacing, slot/mini-slot configuration, or symbol configuration, the mapping information may include information on a mapping rule for determining an SPS resource for each base station (or BWP), an index of the BWP in which the SPS resource is configured, and/or mapping information.

In addition, for beam management (or selection) according to application of a beamforming technique, the SPS configuration information may include information indicating a mapping relationship between a beam through which the SSB and/or reference signal (e.g., DM-RS, CSI-RS, and/or other reference signal) is transmitted and a preamble (or pattern/sequence of a reference signal) radio resource for the SPS resource.

In addition, a radio resource for the above-described SPS resource may be limited only to a resource of a BWP that is previously designated or configured. In this case, the SPS resource configuration information may include a BWP index indicating the corresponding BWP. When an SPS resource for DL SDT operation is configured using a default BWP, an initial BWP, and/or a DL SDT-dedicated BWP at a system level, the SPS resource configuration information may not include the BWP index. When a DL SDT-dedicated BWP is configured, the base station may transmit configuration information of the DL SDT-dedicated BWP and/or SPS resource to the terminal using system information or a dedicated control message.

In addition, when an SPS resource for DL SDT operation is configured in an uplink BWP other than an initial uplink BWP, the corresponding BWP may be configured to have the same properties as the initial BWP. When an SPS resource is configured in a UL/SUL BWP other than the initial uplink BWP, a BWP in which the terminal in the inactive state receives a paging message, system information change notification, system information (e.g., SI, SIB, posSIB, etc.), or MBS services may vary according to the capability of the terminal.

Case1: When the Terminal in the Inactive State can Receive Only in One Downlink BWP

The terminal should be able to receive a paging message, system information change notification, system information (e.g., SI, SIB, posSIB, etc.), or MBS services through a DL BWP in which the SPS resource is configured. Alternatively, the DL BWP in which the SPS resource is configured should be configured as an initial BWP.

Case2: When the Terminal in the Inactive State can Receive in Two or More Downlink BWPs

The terminal may receive a paging message, system information change notification, system information (e.g., SI, SIB, posSIB, etc.), or MBS services through an initial BWP other than a DL BWP in which the SPS resource is configured. Alternatively, the terminal may receive a DL SDT packet and/or control message through a DL BWP in which the SPS resource is configured.

In the above-described DL SDT operation, an encryption function according to a radio layer protocol may not be used or may be limitedly used in a radio section between the base station and the terminal. For example, an encryption function using an encryption key may not be applied, and only a function (e.g., integrity protection) to check integrity of a transmitted message may be applied.

In addition, when the base station transmits a downlink physical layer control channel (or PDCCH) to support the SDT function in the above-described SDT method based on RA procedure and/or SPS resource, a PDCCH (or DCI) transmission region (e.g., CORESET or search space) for supporting the SDT function may be configured to be separated from the existing CORESET or search space for other purposes. Accordingly, the terminal may receive a PDCCH (or DCI) for supporting the SDT function by monitoring a designated (or configured) CORESET or search space for supporting the DL SDT operation.

In addition, in the above-described SDT method based on RA procedure and/or SPS resource, when the condition(s) of using an SPS resource configured for SDT are not satisfied, the SDT using an SPS resource may be restricted even for the terminal to which an SPS resource for SDT is configured. Here, the condition(s) of using an SPS resource may be configured as a combination of one or more among a condition that an area identifier for the above-described SPS configuration information is the same as an area identifier of a base station of a service area in which the terminal currently exists, uplink transmission timing condition for SDT, a condition that a measurement result of a radio channel satisfies a reference for SDT, and a condition that uplink physical layer synchronization is maintained. When the preconfigured condition(s) of using an SPS resource are not satisfied, the terminal may perform the DL SDT reception operation by using the above-described RA procedure for DL SDT reception operation, not an SPS resource for DL SDT reception operation.

After completing SDT based on the above-described RA procedure and/or SPS resource, the terminal may maintain the inactive state or transition to the idle state according to determination (or control) of the base station and/or a request of the terminal. When the terminal transitions to the idle state, the terminal may transition to the idle state without receiving the above-described SPS configuration information for SDT. In the case that the terminal maintains the inactive state, the terminal may perform an SPS resource-based DL SDT reception procedure when a next SDT packet occurs by using newly configured SPS configuration information or the existing SPS configuration information stored in the terminal.

The above-described SDT method based on the RA procedure and/or SPS resource may be applied to a terminal in the connected state to which uplink resources are not allocated. That is, when the terminal in the connected state does not have allocated uplink radio resources or does not have a valid scheduling request (SR) resource for requesting an uplink resource, the terminal in the connected state may perform the DL SDT reception operation by using the RA procedure or SPS resource according to the above-described method and procedure. In the above-described DL SDT reception operation based on the RA procedure and/or SPS resource, information on configuration parameters such as an DL SDT operation period (or window, timer, counter), information indicating whether one-time transmission (or one-shot transmission) is allowed and/or information on the size (or number of messages) of SDT that can be performed as one-time transmission, or information on the size (or number of messages) of a DL SDT packet that can be performed as segmented may be delivered to the terminal through system information and/or an RRC control message.

During one-shot transmission of the DL SDT operation or segmented transmission of the DL SDT operation using two or more segments, the terminal may not perform a radio link failure (RLF) detection, radio link monitoring (RLM), beam failure detection and recovery, and the like. If the DL SDT operation is not completed within the SDT period (or window, timer, counter), it may be determined that the DL SDT operation has failed.

According to a size threshold (or condition value) of downlink SDT configured for DL SDT operation and/or a subsequent data transmission method for segmented transmission of downlink SDT, the terminal may use one or more downlink resources to perform the DL SDT reception operation. Accordingly, a time from the DL SDT reception operation request to the completion of the DL SDT reception operation may be longer than a time required for the existing procedure for resuming a radio link (e.g., resume procedure of the 3GPP LTE/NR system). Accordingly, at least one of the following methods may be considered as a timer-based method of managing (or detecting) a failure of DL SDT operation.
Method 1: Method of managing (or detecting) a DL SDT operation failure based on a DL SDT operation timer
Method 2: Method of managing (or detecting) a DL SDT operation failure based on the legacy radio link resume timer (e.g., T319 timer of the 3GPP LTE/NR system) and a DL SDT operation timer

Method 1 is a method of managing (or detecting) whether the DL SDT operation has failed by using one SDT timer from an indication time of the DL SDT operation until the DL SDT operation is completed. The DL SDT operation timer may be started or restarted whenever the terminal performs downlink reception and/or uplink transmission in order to support (or perform) the DL SDT operation function. When the DL SDT reception operation and/or each uplink transmission for the DL SDT reception operation is not completed until the DL SDT operation timer expires, the terminal and/or the base station may determine a DL SDT operation failure.

For Method 2, a DL SDT operation procedure may be divided into a DL SDT operation initiation step and a DL SDT operation execution step. The DL SDT operation initiation step may refer to a period from a time at which the terminal receives the DL SDT operation indication message to a time at which the terminal transmits a response message (or feedback information) to the DL SDT operation indication message. The DL SDT operation execution step may refer to a step in which the terminal receives a DL SDT packet by using a downlink radio resource. In the DL SDT operation initiation step, the terminal may manage (or detect) whether the DL SDT operation has failed by using the legacy radio link resume timer (e.g., T319 timer), uplink synchronization acquisition management timer, RA window timer, or the like.

In the DL SDT operation execution step, the terminal may manage (or detect) whether the DL SDT operation has failed by using the DL SDT operation timer (or SDT instantaneous timer). The DL SDT operation timer (or SDT instantaneous timer) may be started or restarted whenever the terminal performs reception through a downlink resource or transmission through an uplink radio resource in order to support (or perform) the DL SDT function. That is, the DL SDT operation timer (or SDT instantaneous timer) may be started or restarted every time the terminal receives a DL SDT packet (or the terminal transmits feedback/control information) by using an SPS resource and/or a downlink (or uplink) resource scheduled from the base station. When the transmission of the DL SDT packet is not completed until the DL SDT operation timer (or SDT instantaneous timer) expires, the terminal and/or the base station may determine a DL SDT operation failure. Therefore, in Method 2, by using the legacy radio link resume timer (e.g., T319 timer) and the DL SDT operation timer (or SDT instantaneous timer) for each step, it may be managed (or detected) whether or not the SDT has failed.

If the DL SDT operation has failed, after a preconfigured time period (or timer), in which the reattempt of the DL SDT operation is restricted after the DL SDT operation, ends, the terminal may transition to the idle state or remain in the inactive state. In addition, the terminal may receive the DL SDT packet again which has been interrupted by transitioning to the connected state. Information on the time period (or timer) in which the reattempt of the DL SDT operation is restricted may be delivered to the terminal through system information and/or a control message. Before or when the preconfigured DL SDT period (or window, timer, counter) ends or when the end of the DL SDT period is recognized, the base station may indicate the terminal to transition to the connected state, or the terminal may transmit a control message requesting transition to the connected state to the base station or perform a connection configuration procedure such as an RA procedure.

Here, the counter (or timer) that manages the DL SDT period may be started (or restarted) when a message indicating the DL SDT operation using the above-described RA procedure or SPS resource is transmitted, when the DL SDT operation is performed, at each reception time when two or more DL SDT operations are performed, or when scheduling information (or PDCCH/DCI) for the DL SDT operation is received.

A mapping relationship between the SPS resource for DL SDT operation and the scheduling identifier and/or DMRS configuration information assigned to the corresponding terminal (or terminal group) may be established. Here, the DMRS configuration information may refer to radio resources for DMRS transmission, a DMRS sequence, or a cyclic shift parameter. Configuration information on the mapping relationship may be delivered to the terminal using system information or a control message.

After the above-described SDT operation is initiated or triggered, a downlink non-SDT packet may occur in the terminal. When the DL SDT operation is not initiated, the base station may transmit the non-SDT packet (e.g., data/message of a non-SDT DRB or SRB) by transitioning the terminal in the inactive state to the connected state by transmitting a paging message to the corresponding terminal. However, after the DL SDT operation is initiated, transmission of a paging message using a P-RNTI to the corresponding terminal may be restricted. In this case, the base station may transmit an RRC control message informing the terminal of occurrence of the non-SDT packet through a downlink channel while performing the DL SDT operation.

When the existing paging message is used for transition to the connected state of the terminal during the DL SDT operation, the base station may use the scheduling identifier for DL SDT operation instead of the paging scheduling identifier (i.e., P-RNTI) to transmit a paging message to the terminal. Alternatively, a new RRC layer control message for transition to the connected state of the terminal may be used while performing the DL SDT operation, and the base station may use the scheduling identifier for DL SDT operation to transmit the RRC layer control message indicating transition to the connected state to the terminal.

In the DL SDT operation according to the above-described method, the control information indicating the DL SDT reception operation transmitted by the base station on the PDCCH in step S602 of FIG. 6, step S702 of FIG. 7, or step S802 of FIG. 8 may use a separate DCI Format. That is, if a DCI format for indicating the DL SDT reception operation is separately defined, the corresponding DCI may be transmitted using a separately designated scheduling identifier (e.g., SDT-RNTI) or a paging scheduling identifier (e.g., P-RNTI) for DL SDT operation. When the DCI indicating the DL SDT reception operation is transmitted using the P-RNTI, an indicator for distinguishing the DCI from the DCI for the existing paging message may be included, or an additional field for indicating the SDT purpose may be configured within the existing paging message and/or paging DCI.

In addition, even when the DCI indicating the DL SDT operation is transmitted using the scheduling identifier pre-assigned to the terminal (or terminal group) using the DL SDT configuration information, the separate DCI format may be applied to the control information indicating the DL SDT reception operation. That is, the terminal may identify the control information (or PDCCH/DCI) indicating the DL SDT reception operation using the DCI format, the scheduling identifier, and/or the identification information in the DCI field.

Alternatively, a BWP and/or CORESET resource (e.g., identification information (or resource index) of the BWP and/or CORESET resource) for transmitting the PDCCH/DCI indicating the DL SDT reception operation may separately delivered to the terminal through the system information and/or DL SDT configuration information. In this case, the terminal in the inactive state or the idle state may receive the PDCCH/DCI indicating the DL SDT reception operation by monitoring the corresponding BWP and/or CORESET resource. The corresponding PDCCH/DCI may be transmitted using the scheduling identifier (e.g., SDT-RNTI) designated for SDT, the paging scheduling identifier (e.g., P-RNTI), or the scheduling identifier pre-assigned to the terminal.

In the DL SDT operation according to the above-described method, when the base station transmits the last DL SDT packet, the base station may transmit, to the terminal, an indicator indicating that the corresponding DL SDT packet is the last transmission by using a PDCCH, MAC CE, RLC header (or control information), and/or a PDCP header (or control information).

In the present disclosure, the radio channel quality may be a channel state indicator (CSI), a received signal strength indicator (RSSI), a reference signal received power (RSRP), a reference signal received quality (RSRQ), or a signal to interference and noise ratio (SINR). With respect to the operation of the timer defined or described in the present disclosure, although operations such as start, stop, reset, restart, or expire of the defined timer are not separately described, they mean or include the operations of the corresponding timer or a counter for the corresponding timer.

In the present disclosure, the base station (or cell) may refer to a node B (NodeB), an evolved NodeB, a base transceiver station (BTS), a radio base station, a radio transceiver, an access point, an access node, a road side unit (RSU), a radio remote head (RRH), a transmission point (TP), a transmission and reception point (TRP), or a gNB. In addition, the base station (or, cell) may a CU node or a DU node to which the functional split is applied.

In the present disclosure, the terminal may refer to a UE, a terminal, an access terminal, a mobile terminal, a station, a subscriber station, a mobile station, a portable subscriber station, a node, a device), an Internet of Thing (IoT) device, or a mounted apparatus (e.g., a mounted module/device/terminal or an on-board device/terminal).

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method for receiving a downlink (DL) small data transmission (SDT), performed by a terminal, the method comprising:
receiving DL SDT-related configuration information from a base station;
receiving information indicating a DL SDT reception operation from the base station;
transmitting a response to the information indicating the DL SDT reception operation to the base station; and
receiving a DL SDT packet from the base station.

2. The method according to claim 1, wherein the DL SDT packet has a size less than or equal to a predetermined size and includes intermittently generated data or signaling information.

3. The method according to claim 1, wherein the DL SDT-related configuration information is received from the base station through a control message for transitioning the terminal to a radio resource control (RRC) connection released state.

4. The method according to claim 1, wherein the information indicating the DL SDT reception operation is received as being included in a physical downlink control channel (PDCCH) monitored and received in a time region according to a semi-persistent scheduling (SPS) periodicity indicated by the DL SDT-related configuration information or a discontinuous reception (DRX) operation cycle.

5. The method according to claim 4, wherein the PDCCH is received using a predefined paging scheduling identifier or a scheduling identifier assigned to the terminal through the DL SDT-related configuration information.

6. The method according to claim 1, further comprising, before the transmitting of the response, determining whether the terminal needs to perform a procedure for maintaining uplink synchronization with the base station or whether the uplink synchronization is valid.

7. The method according to claim 6, further comprising: in response to determining that the procedure for maintaining uplink synchronization with the base station needs to be performed, performing a random access (RA) procedure to the base station or transmitting an uplink signal for acquiring uplink synchronization with the base station to the base station by using an uplink radio resource indicated by the information indicating the DL SDT reception operation.

8. The method according to claim 7, wherein in the receiving of the DL SDT packet, information on a timing advance (TA) based on the RA procedure or the uplink signal for acquiring uplink synchronization with the base station is additionally received.

9. The method according to claim 1, further comprising transmitting, to the base station, hybrid automatic repeat request (HARQ) feedback information and/or control information for the DL SDT packet.

10. The method according to claim 9, wherein the control information includes at least one of a result of measuring a quality of a radio channel between the base station and the terminal, a channel quality indicator (CQI) for downlink scheduling between the base station and the terminal, information indicating whether uplink data occurs, assistant information of the terminal, preference information of the terminal, or combinations thereof.

11. The method according to claim 1, further comprising, after the receiving of the DL SDT packet, transitioning to an RRC idle state or remaining in an RRC inactive state according to configuration or indication of the base station.

12. A method for a downlink (DL) small data transmission (SDT) operation, performed by a base station, the method comprising:
transmitting DL SDT-related configuration information to a terminal;
transmitting information indicating a DL SDT reception operation to the terminal;
receiving a response to the information indicating the DL SDT reception operation from the terminal; and
transmitting a DL SDT packet to the terminal.

13. The method according to claim 12, wherein the DL SDT packet has a size less than or equal to a predetermined size and includes intermittently generated data or signaling information.

14. The method according to claim 12, wherein the DL SDT-related configuration information is transmitted to the terminal through a control message for transitioning the terminal to a radio resource control (RRC) connection released state.

15. The method according to claim 12, wherein the information indicating the DL SDT reception operation is transmitted to the terminal in a time region according to a semi-persistent scheduling (SPS) periodicity indicated by the DL SDT-related configuration information or a discontinuous reception (DRX) operation cycle.

16. The method according to claim 12, wherein the transmitting of the DL SDT packet further comprises transmitting, to the terminal, information on a timing advance (TA) based on a random access procedure with the terminal or an uplink signal received from the terminal for uplink synchronization acquisition.

17. A terminal in a mobile communication system, comprising:
a processor; and
a transceiver controlled by the processor,
wherein the processor is executed to perform:
receiving DL SDT-related configuration information from a base station through the transceiver;
receiving information indicating a DL SDT reception operation from the base station through the transceiver;
transmitting a response to the information indicating the DL SDT reception operation to the base station through the transceiver; and
receiving a DL SDT packet from the base station through the transceiver.

18. The terminal according to claim 17, wherein the information indicating the DL SDT reception operation is received as being included in a physical downlink control channel (PDCCH) monitored and received in a time region according to a semi-persistent scheduling (SPS) periodicity indicated by the DL SDT-related configuration information or a discontinuous reception (DRX) operation cycle.

19. The terminal according to claim 17, wherein the processor is further executed to perform: before the transmitting of the response, determining whether the terminal needs to perform a procedure for maintaining uplink synchronization with the base station or whether the uplink synchronization is valid.

20. The terminal according to claim 19, wherein the processor is further executed to perform: in response to determining that the procedure for maintaining uplink synchronization with the base station needs to be performed, performing a random access (RA) procedure to the base station or transmitting an uplink signal for acquiring uplink synchronization with the base station to the base station by using an uplink radio resource indicated by the information indicating the DL SDT reception operation.
